(19) United States
(12) Patent Application Publication
(10) Pub. No.: US 2026/0006647 A1
(43) Pub. Date: Jan. 1, 2026

(54) TECHNIQUES FOR ENHANCED RANDOM ACCESS RESPONSE FOR ON-DEMAND SYSTEM INFORMATION BLOCK

(71) Applicant: QUALCOMM Incorporated, San Diego, CA (US)

(72) Inventors: Jianghong LUO, Skillman, NJ (US); Navid ABEDINI, Basking Ridge, NJ (US); Hung Dinh LY, San Diego, CA (US)

(21) Appl. No.: 18/754,376

(22) Filed: Jun. 26, 2024

(51) Int. Cl. H04W 74/0833; H04W 48/08; H04W 74/00

(52) U.S. Cl. CPC H04W 74/0833; H04W 48/08; H04W 74/006

(57) ABSTRACT

Various aspects generally relate to wireless communication. In some aspects, a user equipment (UE) may transmit, to a network node, a physical random access channel (PRACH) to request an on-demand system information block (SIB) including remaining minimum system information (RMSI). The UE may receive, from the network node in response to the PRACH, a random access response (RAR) protocol data unit (PDU) that includes information for the on-demand SIB. The UE may receive, from the network node, the on-demand SIB based at least in part on the information included in the RAR PDU. In some aspects, the UE may receive, from the network node in response to the PRACH, only a physical downlink control channel (PDCCH) for an RAR during an RAR window. The UE may receive, from the network node, the on-demand SIB based at least in part on the PDCCH for the RAR. Numerous other aspects are described.

### FIELD OF THE DISCLOSURE

Aspects of the present disclosure generally relate to wireless communication and specifically relate to techniques, apparatuses, and methods associated with an enhanced random access response for an on-demand system information block.

### DESCRIPTION OF RELATED ART

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple-access RATs have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, high-precision positioning, and/or radio frequency (RF) sensing, among other examples. As the demand for mobile broadband access continues to increase, further improvements in NR may be implemented, and other radio access technologies such as 6G may be introduced, to further advance mobile broadband evolution.

### SUMMARY

Some aspects described herein relate to a method of wireless communication performed by a user equipment (UE). The method may include transmitting, to a network node, a physical random access channel (PRACH) to request an on-demand system information block (SIB) that includes remaining minimum system information (RMSI). The method may include receiving, from the network node in response to the PRACH, a random access response (RAR) protocol data unit (PDU), wherein the RAR PDU includes information for the on-demand SIB. The method may include receiving, from the network node, the on-demand SIB based at least in part on the information included in the RAR PDU.

Some aspects described herein relate to a method of wireless communication performed by a UE. The method may include transmitting, to a network node, a PRACH to request an on-demand SIB that includes RMSI. The method may include receiving, from the network node in response to the PRACH, only a physical downlink control channel (PDCCH) for an RAR during an RAR window. The method may include receiving, from the network node, the on-demand SIB based at least in part on receiving the PDCCH for the RAR.

Some aspects described herein relate to a method of wireless communication performed by a network node. The method may include receiving, from a UE, a PRACH to request an on-demand SIB that includes RMSI. The method may include transmitting, to the UE in response to the PRACH, one or more RAR PDUs during an RAR window, wherein the one or more RAR PDUs each include information for the on-demand SIB. The method may include transmitting the on-demand SIB based at least in part on the information included in the one or more RAR PDUs.

Some aspects described herein relate to a method of wireless communication performed by a network node. The method may include receiving, from a UE, a PRACH to request an on-demand SIB that includes RMSI. The method may include transmitting, to the UE in response to the PRACH, only a PDCCH for an RAR during an RAR window. The method may include transmitting the on-demand SIB based at least in part on the PDCCH for the RAR.

Some aspects described herein relate to a UE for wireless communication. The UE may include one or more memories and one or more processors coupled to the one or more memories. The one or more processors may be configured to transmit, to a network node, a PRACH to request an on-demand SIB that includes RMSI. The one or more processors may be configured to receive, from the network node in response to the PRACH, an RAR PDU, wherein the RAR PDU includes information for the on-demand SIB. The one or more processors may be configured to receive, from the network node, the on-demand SIB based at least in part on the information included in the RAR PDU. Some aspects described herein relate to a UE for wireless communication.

The UE may include one or more memories and one or more processors coupled to the one or more memories. The one or more processors may be configured to transmit, to a network node, a PRACH to request an on-demand SIB that includes RMSI. The one or more processors may be configured to receive, from the network node in response to the PRACH, only a PDCCH for an RAR during an RAR window. The one or more processors may be configured to receive, from the network node, the on-demand SIB based at least in part on receiving the PDCCH for the RAR.

Some aspects described herein relate to a network node for wireless communication. The network node may include one or more memories and one or more processors coupled to the one or more memories. The one or more processors may be configured to receive, from a UE, a PRACH requesting an on-demand SIB that includes RMSI. The one or more processors may be configured to transmit, to the UE in response to the PRACH, one or more RAR PDUs during an RAR window, wherein the one or more RAR PDUs each include information for the on-demand SIB. The one or more processors may be configured to transmit the on-demand SIB based at least in part on the information included in the one or more RAR PDUs.

Some aspects described herein relate to a network node for wireless communication. The network node may include one or more memories and one or more processors coupled to the one or more memories. The one or more processors may be configured to receive, from a UE, a PRACH to request an on-demand SIB that includes RMSI. The one or more processors may be configured to transmit, to the UE in response to the PRACH, only a PDCCH for an RAR during an RAR window. The one or more processors may be configured to transmit the on-demand SIB based at least in part on the PDCCH for the RAR.

Some aspects described herein relate to a non-transitory computer-readable medium that stores a set of instructions for wireless communication by a UE. The set of instructions, when executed by one or more processors of the UE, may cause the UE to transmit, to a network node, a PRACH to request an on-demand SIB that includes RMSI. The set of instructions, when executed by one or more processors of the UE, may cause the UE to receive, from the network node in response to the PRACH, an RAR PDU, wherein the RAR PDU includes information for the on-demand SIB. The set of instructions, when executed by one or more processors of the UE, may cause the UE to receive, from the network node, the on-demand SIB based at least in part on the information included in the RAR PDU.

Some aspects described herein relate to a non-transitory computer-readable medium that stores a set of instructions for wireless communication by a UE. The set of instructions, when executed by one or more processors of the UE, may cause the UE to transmit, to a network node, a PRACH to request an on-demand SIB that includes RMSI. The set of instructions, when executed by one or more processors of the UE, may cause the UE to receive, from the network node in response to the PRACH, only a PDCCH for an RAR during an RAR window. The set of instructions, when executed by one or more processors of the UE, may cause the UE to receive, from the network node, the on-demand SIB based at least in part on receiving the PDCCH for the RAR.

Some aspects described herein relate to a non-transitory computer-readable medium that stores a set of instructions for wireless communication by a network node. The set of instructions, when executed by one or more processors of the network node, may cause the network node to receive, from a UE, a PRACH requesting an on-demand SIB that includes RMSI. The set of instructions, when executed by one or more processors of the network node, may cause the network node to transmit, to the UE in response to the PRACH, one or more RAR PDUs during an RAR window, wherein the one or more RAR PDUs each include information for the on-demand SIB. The set of instructions, when executed by one or more processors of the network node, may cause the network node to transmit the on-demand SIB based at least in part on the information included in the one or more RAR PDUs.

Some aspects described herein relate to a non-transitory computer-readable medium that stores a set of instructions for wireless communication by a network node. The set of instructions, when executed by one or more processors of the network node, may cause the network node to receive, from a UE, a PRACH to request an on-demand SIB that includes RMSI. The set of instructions, when executed by one or more processors of the network node, may cause the network node to transmit, to the UE in response to the PRACH, only a PDCCH for an RAR during an RAR window. The set of instructions, when executed by one or more processors of the network node, may cause the network node to transmit the on-demand SIB based at least in part on the PDCCH for the RAR.

Some aspects described herein relate to an apparatus for wireless communication. The apparatus may include means for transmitting, to a network node, a PRACH to request an on-demand SIB that includes RMSI. The apparatus may include means for receiving, from the network node in response to the PRACH, an RAR PDU, wherein the RAR PDU includes information for the on-demand SIB. The apparatus may include means for receiving, from the network node, the on-demand SIB based at least in part on the information included in the RAR PDU.

Some aspects described herein relate to an apparatus for wireless communication. The apparatus may include means for transmitting, to a network node, a PRACH to request an on-demand SIB that includes RMSI. The apparatus may include means for receiving, from the network node in response to the PRACH, only a PDCCH for an RAR during an RAR window. The apparatus may include means for receiving, from the network node, the on-demand SIB based at least in part on receiving the PDCCH for the RAR.

Some aspects described herein relate to an apparatus for wireless communication. The apparatus may include means for receiving, from a UE, a PRACH requesting an on-demand SIB that includes RMSI. The apparatus may include means for transmitting, to the UE in response to the PRACH, one or more RAR PDUs during an RAR window, wherein the one or more RAR PDUs each include information for the on-demand SIB. The apparatus may include means for transmitting the on-demand SIB based at least in part on the information included in the one or more RAR PDUs.

Some aspects described herein relate to an apparatus for wireless communication. The apparatus may include means for receiving, from a UE, a PRACH to request an on-demand SIB that includes RMSI. The apparatus may include means for transmitting, to the UE in response to the PRACH, only a PDCCH for an RAR during an RAR window. The apparatus may include means for transmitting the on-demand SIB based at least in part on the PDCCH for the RAR.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure, but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless network, in accordance with the present disclosure.

FIG. 2 is a diagram illustrating an example network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of a four-step random access procedure in accordance with the present disclosure.

FIG. 5 is a diagram illustrating an example of a two-step random access procedure in accordance with the present disclosure.

FIGS. 6A-6C are diagrams illustrating examples associated with an on-demand system information block (SIB), in accordance with the present disclosure.

FIG. 7 is a diagram illustrating an example associated with on-demand other system information, in accordance with the present disclosure.

FIG. 8 is a diagram illustrating an example associated with a random access procedure for requesting an on-demand SIB, in accordance with the present disclosure.

FIGS. 9-10 are diagrams illustrating examples associated with an enhanced random access response for an on-demand SIB, in accordance with the present disclosure.

FIGS. 11-12 are flowcharts illustrating example processes performed, for example, by a UE in accordance with the present disclosure.

FIGS. 13-14 are flowcharts illustrating example processes performed, for example, by a network node in accordance with the present disclosure.

FIG. 15-16 are diagrams of example apparatuses for wireless communication in accordance with the present disclosure.

### DETAILED DESCRIPTION

Various aspects of the present disclosure are described hereinafter with reference to the accompanying drawings. However, aspects of the present disclosure may be embodied in many different forms and is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Network energy savings (NES) and/or network energy efficiency measures are expected to have increased importance in wireless network operations for various reasons, such as climate change mitigation, environmental sustainability, and/or network cost reduction, among other examples. For example, although 5G New Radio (NR) generally offers a significant energy efficiency improvement per gigabyte over previous generations (e.g., long term evolution (LTE)), some NR use cases and/or the adoption of millimeter wave frequencies may require more network sites, more network antennas, larger bandwidths, and/or more frequency bands, among other examples, which may lead to more efficient wireless networks that nonetheless have higher energy requirements and/or cause more emissions than previous wireless network generations. Furthermore, energy accounts for a significant proportion of the cost to operate a wireless network. For example, according to some estimates, energy costs (e.g., fuel and electricity) are about one-fourth of the total cost to operate a wireless network, and about half of the energy consumption is associated with a radio access network (RAN). Accordingly, measures to increase network energy savings and/or improve energy efficiency are factors that may drive adoption and/or expansion of wireless networks.

One technique to increase energy efficiency in a RAN is to enable “on-demand” broadcast transmissions by a network node and/or a cell. For example, to reduce power consumption at a network node, the network node may transmit certain broadcast communications (e.g., system information communications, synchronization signal blocks (SSBs), and/or system information blocks (SIBs)) in an on-demand manner (e.g., upon request, rather than on a periodic basis or following a periodic schedule). In some examples, an on-demand communication may be a communication that carries remaining minimum system information (RMSI), such as a SIB type 1 (SIB1) or another SIB (e.g., as defined, or otherwise fixed, by a wireless communication standard, such as the 3GPP). In some examples, an SSB and/or SIB1 may be transmitted via a cell to support initial access, measurement, camping, and/or cell selection or reselection by a user equipment (UE). Typically, such communications are periodically broadcasted via the cell (e.g., following a periodic schedule where the communication(s) are transmitted one or more times, and often beamswept in multiple beam directions, in each period) so that idle and/or inactive UEs and/or UEs moving into a geographic region of a cell can receive the communications and establish a connection via the cell. Therefore, one way to reduce network power consumption is to reduce transmissions of such communications such that, for example, an SSB and/or SIB1 is transmitted less frequently by a cell operating in an NES mode (or NES state).

For example, a cell may operate in an NES mode or an NES state associated with an on-demand SIB1, where the SIB1 is transmitted only upon request by a UE, in order to reduce overhead and/or reduce power consumption. For example, a cell may operate in an NES mode or an NES state associated with an on-demand SIB1 during periods with low activity (e.g., there are not many UEs entering and exiting the coverage of the cell, or there are not many UEs that are attempting to establish a connection), in which case periodically broadcasting SIB1 (e.g., every 20 or 160 milliseconds) may be wasteful. In such cases, the cell may broadcast SIB1 only on-demand, or only upon request by a UE, where the request may be carried in an uplink wakeup signal (UL-WUS). For example, a UE in an idle or inactive mode or a UE that has detected or selected the cell operating in accordance with the on-demand SIB1 configuration may transmit an UL-WUS to request and acquire the on-demand SIB1 (e.g., in order to camp on the cell, connect to the cell, or prepare to connect to the cell).

In some cases, the UL-WUS may be configured as a physical random access channel (PRACH) that includes a dedicated preamble reserved to requesting the on-demand SIB1 (e.g., distinct from PRACH preambles for the purpose of initial access). For example, a UE may transmit the PRACH to request the on-demand SIB1 to a target cell, which may be the NES cell or an active cell that acts as a source cell for transmission of the on-demand SIB1 associated with the NES cell in addition to periodically transmitting SIB1 for the active cell. The UE may then follow an existing or baseline contention-free random access procedure for monitoring for a random access response (RAR) from the target cell during an RAR window. For example, the RAR generally includes a physical downlink control channel (PDCCH) for the RAR, which schedules a physical downlink shared channel (PDSCH) for the RAR. Upon successfully receiving the PDCCH and the PDSCH for the RAR within the RAR window, the UE then monitors for a PDCCH for the on-demand SIB1 during a time window indicated by a configuration of the UL-WUS, where the PDCCH for the on-demand SIB1 schedules a PDSCH that includes the on-demand SIB1. Accordingly, when the UE follows the existing or baseline contention-free random access procedure to request and acquire the on-demand SIB1, there are several downlink signaling messages between the PRACH transmission and the PDSCH that includes the on-demand SIB1. In particular, the target cell transmits a PDCCH for the RAR, a PDSCH for the RAR, and a PDCCH for the on-demand SIB1, which can increase energy consumption by the target cell and/or increase latency for acquiring the on-demand SIB1.

Various aspects relate generally to an enhanced RAR for an on-demand SIB1. Some aspects more specifically relate to consolidating downlink signaling messages between a PRACH transmission requesting an on-demand SIB1 and a PDSCH that includes the on-demand SIB1 in order to increase network energy savings and/or reduce latency associated with acquiring the on-demand SIB1. For example, in some aspects, a target cell that receives a PRACH requesting an on-demand SIB1 may transmit, to the UE requesting the on-demand SIB1 during an RAR window, an RAR PDCCH that schedules an RAR PDSCH that includes an enhanced RAR protocol data unit (PDU). For example, the enhanced RAR PDU may include full or partial scheduling information for the PDSCH that includes the on-demand SIB1, whereby the network node may drop (e.g., not transmit) the PDCCH scheduling the PDSCH that includes the on-demand SIB1. In this way, the enhanced RAR PDU may increase energy savings for the UE and the network node (e.g., because the network node does not transmit the PDCCH for the on-demand SIB1, and the UE does not have to monitor for or decode the PDCCH for the on-demand SIB1) and/or enable a higher reliability for the on-demand SIB1. Additionally, or alternatively, in some aspects, the target cell that receives the PRACH requesting the on-demand SIB1 may transmit, to the UE requesting the on-demand SIB1 during an RAR window, an enhanced RAR PDCCH that indicates the dedicated preamble for requesting the on-demand SIB1 as an acknowledgement for reception of the PRACH. Accordingly, the network node may then drop (e.g., not transmit) the PDSCH for the RAR. In some aspects, the enhanced PDCCH may further include scheduling information for the PDSCH that includes the on-demand SIB1, in which case the network node may drop (e.g., not transmit) the PDSCH for the RAR in addition to the PDCCH scheduling the on-demand SIB1. In this way, in addition to conserving energy that would otherwise be consumed transmitting and/or receiving the RAR PDSCH and/or the PDCCH for the on-demand SIB1, indicating dynamic scheduling information for the on-demand SIB1 within the enhanced RAR PDCCH may result in a lower failure rate because the UE does not have to detect and decode the RAR PDSCH to obtain the dynamic scheduling information.

Multiple-access radio access technologies (RATs) have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the Third Generation Partnership Project (3GPP). 5G NR supports various technologies and use cases including enhanced mobile broadband (eMBB), ultra-reliable low-latency communication (URLLC), massive machine-type communication (mMTC), millimeter wave (mmWave) technology, beamforming, network slicing, edge computing, Internet of Things (IoT) connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) UE functionality, industrial connectivity, multiple-subscriber implementations, high-precision positioning, radio frequency (RF) sensing, and/or artificial intelligence or machine learning (AI/ML), among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

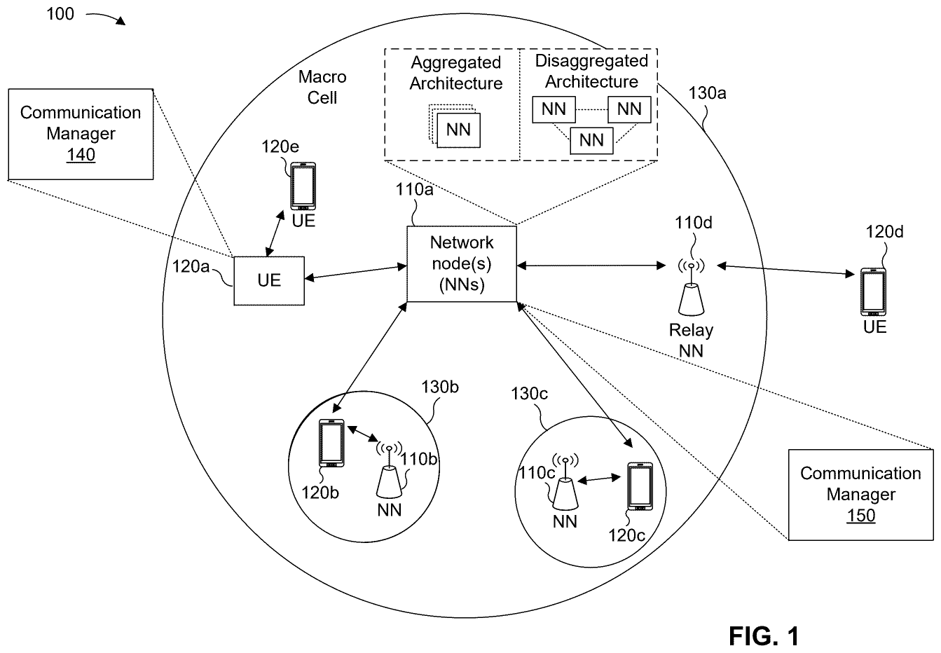

FIG. 1 is a diagram illustrating an example of a wireless communication network 100 in accordance with the present disclosure. The wireless communication network 100 may be or may include elements of a 5G (or NR) network or a 6G network, among other examples. The wireless communication network 100 may include multiple network nodes 110, shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120e.

The network nodes 110 and the UEs 120 of the wireless communication network 100 may communicate using the electromagnetic spectrum, which may be subdivided by frequency or wavelength into various classes, bands, carriers, or channels. For example, devices of the wireless communication network 100 may communicate using one or more operating bands. In some aspects, multiple wireless networks 100 may be deployed in a given geographic area. Each wireless communication network 100 may support a particular RAT (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHZ), FR4 (52.6 GHz through 114.25 GHZ), and FR5 (114.25 GHz through 300 GHz). Although a portion of FR1 is greater than 6 GHz, FR1 is often referred to (interchangeably) as a “Sub-6 GHZ” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHZ,” if used herein, may broadly refer to frequencies that are less than 6 GHZ, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 may implement dynamic spectrum sharing (DSS), in which multiple RATs (for example, 4G/LTE and 5G/NR) are implemented with dynamic bandwidth allocation (for example, based on user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 110 may include one or more devices, components, or systems that enable communication between a UE 120 and one or more devices, components, or systems of the wireless communication network 100. A network node 110 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a radio access network (RAN).

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node (having an aggregated architecture), meaning that the network node 110 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 120 and a core network of the wireless communication network 100.

Alternatively, and as also shown, a network node 110 may be a disaggregated network node (sometimes referred to as a disaggregated base station), meaning that the network node 110 may implement a radio protocol stack that is physically distributed and/or logically distributed among two or more nodes in the same geographic location or in different geographic locations. For example, a disaggregated network node may have a disaggregated architecture. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 110 of the wireless communication network 100 may include one or more central units (CUs), one or more distributed units (DUs), and/or one or more radio units (RUs). A CU may host one or more higher layer control functions, such as radio resource control (RRC) functions, packet data convergence protocol (PDCP) functions, and/or service data adaptation protocol (SDAP) functions, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (iFFT), beamforming, physical random access channel (PRACH) extraction and filtering, and/or scheduling of resources for one or more UEs 120, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 120.

In some aspects, a single network node 110 may include a combination of one or more CUs, one or more DUs, and/or one or more RUs. Additionally or alternatively, a network node 110 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In some examples, a cell may not necessarily be stationary. For example, the geographic area of the cell may move according to the location of an associated mobile network node 110 (for example, a train, a satellite base station, an unmanned aerial vehicle, or a NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c. Various different types of network nodes 110 may generally transmit at different power levels, serve different coverage areas, and/or have different impacts on interference in the wireless communication network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink channels may include one or more control channels and one or more data channels. A downlink control channel may be used to transmit downlink control information (DCI) (for example, scheduling information, reference signals, and/or configuration information) from a network node 110 to a UE 120. A downlink data channel may be used to transmit downlink data (for example, user data associated with a UE 120) from a network node 110 to a UE 120. Downlink control channels may include one or more physical downlink control channels (PDCCHs), and downlink data channels may include one or more physical downlink shared channels (PDSCHs). Uplink channels may similarly include one or more control channels and one or more data channels. An uplink control channel may be used to transmit uplink control information (UCI) (for example, reference signals and/or feedback corresponding to one or more downlink transmissions) from a UE 120 to a network node 110. An uplink data channel may be used to transmit uplink data (for example, user data associated with a UE 120) from a UE 120 to a network node 110. Uplink control channels may include one or more physical uplink control channels (PUCCHs), and uplink data channels may include one or more physical uplink shared channels (PUSCHs). The downlink and the uplink may each include a set of resources on which the network node 110 and the UE 120 may communicate.

Downlink and uplink resources may include time domain resources (frames, subframes, slots, and/or symbols), frequency domain resources (frequency bands, component carriers, subcarriers, resource blocks, and/or resource elements), and/or spatial domain resources (particular transmit directions and/or beam parameters). Frequency domain resources of some bands may be subdivided into bandwidth parts (BWPs). A BWP may be a continuous block of frequency domain resources (for example, a continuous block of resource blocks) that are allocated for one or more UEs 120. A UE 120 may be configured with both an uplink BWP and a downlink BWP (where the uplink BWP and the downlink BWP may be the same BWP or different BWPs). A BWP may be dynamically configured (for example, by a network node 110 transmitting a DCI configuration to the one or more UEs 120) and/or reconfigured, which means that a BWP can be adjusted in real-time (or near-real-time) based on changing network conditions in the wireless communication network 100 and/or based on the specific requirements of the one or more UEs 120. This enables more efficient use of the available frequency domain resources in the wireless communication network 100 because fewer frequency domain resources may be allocated to a BWP for a UE 120 (which may reduce the quantity of frequency domain resources that a UE 120 is required to monitor), leaving more frequency domain resources to be spread across multiple UEs 120. Thus, BWPs may also assist in the implementation of lower-capability UEs 120 by facilitating the configuration of smaller bandwidths for communication by such UEs 120.

As described above, in some aspects, the wireless communication network 100 may be, may include, or may be included in, an IAB network. In an IAB network, at least one network node 110 is an anchor network node that communicates with a core network. An anchor network node 110 may also be referred to as an IAB donor (or “IAB-donor”). The anchor network node 110 may connect to the core network via a wired backhaul link. For example, an Ng interface of the anchor network node 110 may terminate at the core network. Additionally or alternatively, an anchor network node 110 may connect to one or more devices of the core network that provide a core access and mobility management function (AMF). An IAB network also generally includes multiple non-anchor network nodes 110, which may also be referred to as relay network nodes or simply as IAB nodes (or “IAB-nodes”). Each non-anchor network node 110 may communicate directly with the anchor network node 110 via a wireless backhaul link to access the core network, or may communicate indirectly with the anchor network node 110 via one or more other non-anchor network nodes 110 and associated wireless backhaul links that form a backhaul path to the core network. Some anchor network node 110 or other non-anchor network node 110 may also communicate directly with one or more UEs 120 via wireless access links that carry access traffic. In some examples, network resources for wireless communication (such as time resources, frequency resources, and/or spatial resources) may be shared between access links and backhaul links.

In some examples, any network node 110 that relays communications may be referred to as a relay network node, a relay station, or simply as a relay. A relay may receive a transmission of a communication from an upstream station (for example, another network node 110 or a UE 120) and transmit the communication to a downstream station (for example, a UE 120 or another network node 110). In this case, the wireless communication network 100 may include or be referred to as a “multi-hop network.” In the example shown in FIG. 1, the network node 110d (for example, a relay network node) may communicate with the network node 110a (for example, a macro network node) and the UE 120d in order to facilitate communication between the network node 110a and the UE 120d. Additionally or alternatively, a UE 120 may be or may operate as a relay station that can relay transmissions to or from other UEs 120. A UE 120 that relays communications may be referred to as a UE relay or a relay UE, among other examples.

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system.

Some UEs 120 may be considered machine-type communication (MTC) UEs, evolved or enhanced machine-type communication (eMTC), UEs, further enhanced eMTC (feMTC) UEs, or enhanced feMTC (efeMTC) UEs, or further evolutions thereof, all of which may be simply referred to as “MTC UEs”. An MTC UE may be, may include, or may be included in or coupled with a robot, an uncrewed aerial vehicle, a remote device, a sensor, a meter, a monitor, and/or a location tag. Some UEs 120 may be considered IoT devices and/or may be implemented as NB-IoT (narrowband IoT) devices. An IoT UE or NB-IoT device may be, may include, or may be included in or coupled with an industrial machine, an appliance, a refrigerator, a doorbell camera device, a home automation device, and/or a light fixture, among other examples. Some UEs 120 may be considered Customer Premises Equipment, which may include telecommunications devices that are installed at a customer location (such as a home or office) to enable access to a service provider's network (such as included in or in communication with the wireless communication network 100).

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, enhanced mobile broadband (eMBB), and/or precise positioning in the wireless communication network 100, among other examples. A third category of UEs 120 may have mid-tier complexity and/or capability (for example, a capability between UEs 120 of the first category and UEs 120 of the second capability). A UE 120 of the third category may be referred to as a reduced capacity UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, and/or cameras that are associated with a limited bandwidth, power capacity, and/or transmission range, among other examples. RedCap UEs may support healthcare environments, building automation, electrical distribution, process automation, transport and logistics, and/or smart city deployments, among other examples.

In some examples, two or more UEs 120 (for example, shown as UE 120a and UE 120e) may communicate directly with one another using sidelink communications (for example, without communicating by way of a network node 110 as an intermediary). As an example, the UE 120a may directly transmit data, control information, or other signaling as a sidelink communication to the UE 120e. This is in contrast to, for example, the UE 120a first transmitting data in an UL communication to a network node 110, which then transmits the data to the UE 120e in a DL communication. In various examples, the UEs 120 may transmit and receive sidelink communications using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 110 may schedule and/or allocate resources for sidelink communications between UEs 120 in the wireless communication network 100. In some other deployments and configurations, a UE 120 (instead of a network node 110) may perform, or collaborate or negotiate with one or more other UEs to perform, scheduling operations, resource selection operations, and/or other operations for sidelink communications.

In various examples, some of the network nodes 110 and the UEs 120 of the wireless communication network 100 may be configured for full-duplex operation in addition to half-duplex operation. A network node 110 or a UE 120 operating in a half-duplex mode may perform only one of transmission or reception during particular time resources, such as during particular slots, symbols, or other time periods. Half-duplex operation may involve time-division duplexing (TDD), in which DL transmissions of the network node 110 and UL transmissions of the UE 120 do not occur in the same time resources (that is, the transmissions do not overlap in time). In contrast, a network node 110 or a UE 120 operating in a full-duplex mode can transmit and receive communications concurrently (for example, in the same time resources). By operating in a full-duplex mode, network nodes 110 and/or UEs 120 may generally increase the capacity of the network and the radio access link. In some examples, full-duplex operation may involve frequency-division duplexing (FDD), in which DL transmissions of the network node 110 are performed in a first frequency band or on a first component carrier and transmissions of the UE 120 are performed in a second frequency band or on a second component carrier different than the first frequency band or the first component carrier, respectively. In some examples, full-duplex operation may be enabled for a UE 120 but not for a network node 110. For example, a UE 120 may simultaneously transmit an UL transmission to a first network node 110 and receive a DL transmission from a second network node 110 in the same time resources. In some other examples, full-duplex operation may be enabled for a network node 110 but not for a UE 120. For example, a network node 110 may simultaneously transmit a DL transmission to a first UE 120 and receive an UL transmission from a second UE 120 in the same time resources. In some other examples, full-duplex operation may be enabled for both a network node 110 and a UE 120.

In some examples, the UEs 120 and the network nodes 110 may perform MIMO communication. “MIMO” generally refers to transmitting or receiving multiple signals (such as multiple layers or multiple data streams) simultaneously over the same time and frequency resources. MIMO techniques generally exploit multipath propagation. MIMO may be implemented using various spatial processing or spatial multiplexing operations. In some examples, MIMO may support simultaneous transmission to multiple receivers, referred to as multi-user MIMO (MU-MIMO). Some RATs may employ advanced MIMO techniques, such as mTRP operation (including redundant transmission or reception on multiple TRPs), reciprocity in the time domain or the frequency domain, single-frequency-network (SFN) transmission, or non-coherent joint transmission (NC-JT).

In some aspects, the UE 120 may include a communication manager 140. As described in more detail elsewhere herein, the communication manager 140 may transmit, to a network node 110, a PRACH to request an on-demand SIB that includes RMSI; receive, from the network node 110 in response to the PRACH, an RAR PDU, wherein the RAR PDU includes information for the on-demand SIB; and receive, from the network node 110, the on-demand SIB based at least in part on the information included in the RAR PDU. Additionally, or alternatively, the communication manager 140 may perform one or more other operations described herein.

In some aspects, the UE 120 may include a communication manager 140. As described in more detail elsewhere herein, the communication manager 140 may transmit, to a network node 110, a PRACH to request an on-demand SIB that includes RMSI; receive, from the network node 110 in response to the PRACH, only a PDCCH for an RAR during an RAR window; and receive, from the network node 110, the on-demand SIB based at least in part on receiving the PDCCH for the RAR. Additionally, or alternatively, the communication manager 140 may perform one or more other operations described herein.

In some aspects, the network node 110 may include a communication manager 150. As described in more detail elsewhere herein, the communication manager 150 may receive, from a UE 120, a PRACH requesting an on-demand SIB that includes RMSI; transmit, to the UE 120 in response to the PRACH, one or more RAR PDUs during an RAR window, wherein the one or more RAR PDUs each include information for the on-demand SIB; and transmit the on-demand SIB based at least in part on the information included in the one or more RAR PDUs. Additionally, or alternatively, the communication manager 150 may perform one or more other operations described herein.

In some aspects, the network node 110 may include a communication manager 150. As described in more detail elsewhere herein, the communication manager 150 may receive, from a UE 120, a PRACH to request an on-demand SIB that includes RMSI; transmit, to the UE 120 in response to the PRACH, only a PDCCH for an RAR during an RAR window; and transmit the on-demand SIB based at least in part on the PDCCH for the RAR. Additionally, or alternatively, the communication manager 150 may perform one or more other operations described herein.

As indicated above, FIG. 1 is provided as an example. Other examples may differ from what is described with regard to FIG. 1.

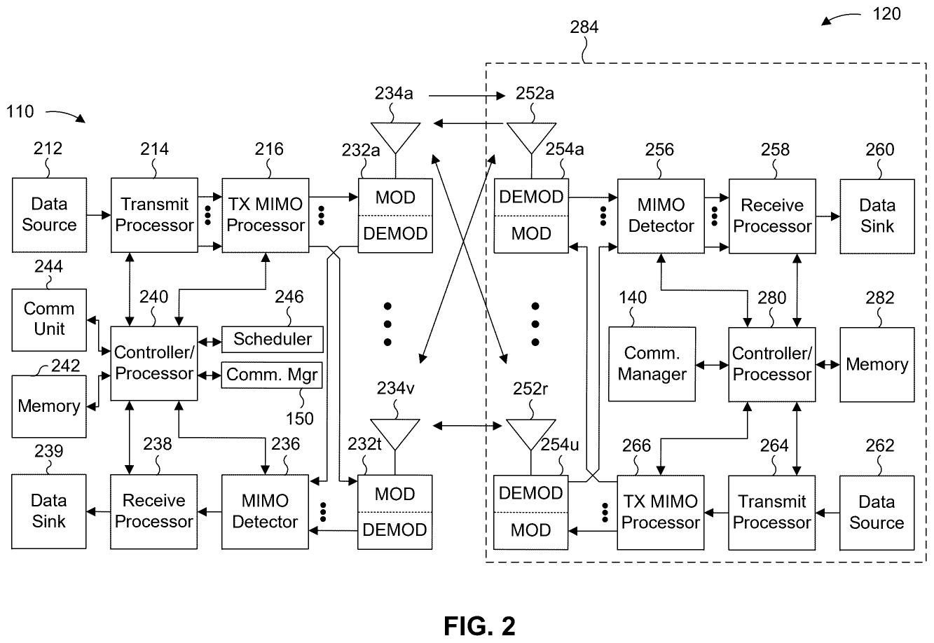

FIG. 2 is a diagram illustrating an example network node 110 in communication with an example UE 120 in a wireless network.

As shown in FIG. 2, the network node 110 may include a data source 212, a transmit processor 214, a transmit (TX) MIMO processor 216, a set of modems 232 (shown as 232a through 232t, where t≥1), a set of antennas 234 (shown as 234a through 234v, where v≥1), a MIMO detector 236, a receive processor 238, a data sink 239, a controller/processor 240, a memory 242, a communication unit 244, a scheduler 246, and/or a communication manager 150, among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 110. The transceiver may be under control of and used by one or more processors, such as the controller/processor 240, and in some aspects in conjunction with processor-readable code stored in the memory 242, to perform aspects of the methods, processes, and/or operations described herein. In some aspects, the network node 110 may include one or more interfaces, communication components, and/or other components that facilitate communication with the UE 120 or another network node.

The terms “processor,” “controller,” or “controller/processor” may refer to one or more controllers and/or one or more processors. For example, reference to “a/the processor,” “a/the controller/processor,” or the like (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 110 may include transmit processor 214, TX MIMO processor 216, MIMO detector 236, receive processor 238, and/or controller/processor 240. Similarly, one or more processors of the UE 120 may include MIMO detector 256, receive processor 258, transmit processor 264, TX MIMO processor 266, and/or controller/processor 280.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories.

For downlink communication from the network node 110 to the UE 120, the transmit processor 214 may receive data (“downlink data”) intended for the UE 120 (or a set of UEs that includes the UE 120) from the data source 212 (such as a data pipeline or a data queue). In some examples, the transmit processor 214 may select one or more MCSs for the UE 120 in accordance with one or more channel quality indicators (CQIs) received from the UE 120. The network node 110 may process the data (for example, including encoding the data) for transmission to the UE 120 on a downlink in accordance with the MCS(s) selected for the UE 120 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a demodulation reference signal (DMRS), or a channel state information (CSI) reference signal (CSI-RS)) and/or synchronization signals (for example, a primary synchronization signal (PSS) or a secondary synchronization signals (SSS)).

The TX MIMO processor 216 may perform spatial processing (for example, precoding) on the data symbols, the control symbols, the overhead symbols, and/or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing (OFDM)) to obtain an output sample stream. Each modem 232 may further use the respective modulator component to process (for example, convert to analog, amplify, filter, and/or upconvert) the output sample stream to obtain a time domain downlink signal. The modems 232a through 232t may together transmit a set of downlink signals (for example, T downlink signals) via the corresponding set of antennas 234.

A downlink signal may include a DCI communication, a MAC control element (MAC-CE) communication, an RRC communication, a downlink reference signal, or another type of downlink communication. Downlink signals may be transmitted on a PDCCH, a PDSCH, and/or on another downlink channel. A downlink signal may carry one or more transport blocks (TBs) of data. A TB may be a unit of data that is transmitted over an air interface in the wireless communication network 100. A data stream (for example, from the data source 212) may be encoded into multiple TBs for transmission over the air interface. The quantity of TBs used to carry the data associated with a particular data stream may be associated with a TB size common to the multiple TBs. The TB size may be based on or otherwise associated with radio channel conditions of the air interface, the MCS used for encoding the data, the downlink resources allocated for transmitting the data, and/or another parameter. In general, the larger the TB size, the greater the amount of data that can be transmitted in a single transmission, which reduces signaling overhead. However, larger TB sizes may be more prone to transmission and/or reception errors than smaller TB sizes, but such errors may be mitigated by more robust error correction techniques.

For uplink communication from the UE 120 to the network node 110, uplink signals from the UE 120 may be received by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 110 may use the scheduler 246 to schedule one or more UEs 120 for downlink or uplink communications. In some aspects, the scheduler 246 may use DCI to dynamically schedule DL transmissions to the UE 120 and/or UL transmissions from the UE 120. In some examples, the scheduler 246 may allocate recurring time domain resources and/or frequency domain resources that the UE 120 may use to transmit and/or receive communications using an RRC configuration (for example, a semi-static configuration), for example, to perform semi-persistent scheduling (SPS) or to configure a configured grant (CG) for the UE 120.

One or more of the transmit processor 214, the TX MIMO processor 216, the modem 232, the antenna 234, the MIMO detector 236, the receive processor 238, and/or the controller/processor 240 may be included in an RF chain of the network node 110. An RF chain may include one or more filters, mixers, oscillators, amplifiers, analog-to-digital converters (ADCs), and/or other devices that convert between an analog signal (such as for transmission or reception via an air interface) and a digital signal (such as for processing by one or more processors of the network node 110). In some aspects, the RF chain may be or may be included in a transceiver of the network node 110.

In some examples, the network node 110 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 110 may use the communication unit 244 to transmit and/or receive data associated with the UE 120 or to perform network control signaling, among other examples. The communication unit 244 may include a transceiver and/or an interface, such as a network interface.

The UE 120 may include a set of antennas 252 (shown as antennas 252a through 252r, where r≥1), a set of modems 254 (shown as modems 254a through 254u, where u≥1), a MIMO detector 256, a receive processor 258, a data sink 260, a data source 262, a transmit processor 264, a TX MIMO processor 266, a controller/processor 280, a memory 282, and/or a communication manager 140, among other examples. One or more of the components of the UE 120 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be under control of and used by one or more processors, such as the controller/processor 280, and in some aspects in conjunction with processor-readable code stored in the memory 282, to perform aspects of the methods, processes, or operations described herein. In some aspects, the UE 120 may include another interface, another communication component, and/or another component that facilitates communication with the network node 110 and/or another UE 120.

For downlink communication from the network node 110 to the UE 120, the set of antennas 252 may receive the downlink communications or signals from the network node 110 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 120 to the data sink 260 (which may include a data pipeline, a data queue, and/or an application executed on the UE 120), and may provide decoded control information and system information to the controller/processor 280.

For uplink communication from the UE 120 to the network node 110, the transmit processor 264 may receive and process data (“uplink data”) from a data source 262 (such as a data pipeline, a data queue, and/or an application executed on the UE 120) and control information from the controller/processor 280. The control information may include one or more parameters, feedback, one or more signal measurements, and/or other types of control information. In some aspects, the receive processor 258 and/or the controller/processor 280 may determine, for a received signal (such as received from the network node 110 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a CQI parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 120 by the network node 110.

The transmit processor 264 may generate reference symbols for one or more reference signals, such as an uplink DMRS, an uplink sounding reference signal (SRS), and/or another type of reference signal. The symbols from the transmit processor 264 may be precoded by the TX MIMO processor 266, if applicable, and further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, U output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254u may transmit a set of uplink signals (for example, R uplink signals or U uplink symbols) via the corresponding set of antennas 252. An uplink signal may include a UCI communication, a MAC-CE communication, an RRC communication, or another type of uplink communication. Uplink signals may be transmitted on a PUSCH, a PUCCH, and/or another type of uplink channel. An uplink signal may carry one or more TBs of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range.

The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal. In some implementations, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 120 or network nodes 110 may include different numbers of antenna elements. For example, a UE 120 may include a single antenna element, two antenna elements, four antenna elements, eight antenna elements, or a different number of antenna elements. As another example, a network node 110 may include eight antenna elements, 24 antenna elements, 64 antenna elements, 128 antenna elements, or a different number of antenna elements. Generally, a larger number of antenna elements may provide increased control over parameters for beam generation relative to a smaller number of antenna elements, whereas a smaller number of antenna elements may be less complex to implement and may use less power than a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

In some aspects, the controller/processor 280 may be a component of a processing system. A processing system may generally be a system or a series of machines or components that receives inputs and processes the inputs to produce a set of outputs (which may be passed to other systems or components of, for example, the UE 120). For example, a processing system of the UE 120 may be a system that includes the various other components or subcomponents of the UE 120.

The processing system of the UE 120 may interface with one or more other components of the UE 120, may process information received from one or more other components (such as inputs or signals), or may output information to one or more other components. For example, a chip or modem of the UE 120 may include a processing system, a first interface to receive or obtain information, and a second interface to output, transmit, or provide information. In some examples, the first interface may be an interface between the processing system of the chip or modem and a receiver, such that the UE 120 may receive information or signal inputs, and the information may be passed to the processing system. In some examples, the second interface may be an interface between the processing system of the chip or modem and a transmitter, such that the UE 120 may transmit information output from the chip or modem. A person having ordinary skill in the art will readily recognize that the second interface also may obtain or receive information or signal inputs, and the first interface also may output, transmit, or provide information.

In some aspects, the controller/processor 240 may be a component of a processing system. A processing system may generally be a system or a series of machines or components that receives inputs and processes the inputs to produce a set of outputs (which may be passed to other systems or components of, for example, the network node 110). For example, a processing system of the network node 110 may be a system that includes the various other components or subcomponents of the network node 110.

The processing system of the network node 110 may interface with one or more other components of the network node 110, may process information received from one or more other components (such as inputs or signals), or may output information to one or more other components. For example, a chip or modem of the network node 110 may include a processing system, a first interface to receive or obtain information, and a second interface to output, transmit, or provide information. In some examples, the first interface may be an interface between the processing system of the chip or modem and a receiver, such that the network node 110 may receive information or signal inputs, and the information may be passed to the processing system. In some examples, the second interface may be an interface between the processing system of the chip or modem and a transmitter, such that the network node 110 may transmit information output from the chip or modem. A person having ordinary skill in the art will readily recognize that the second interface also may obtain or receive information or signal inputs, and the first interface also may output, transmit, or provide information.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

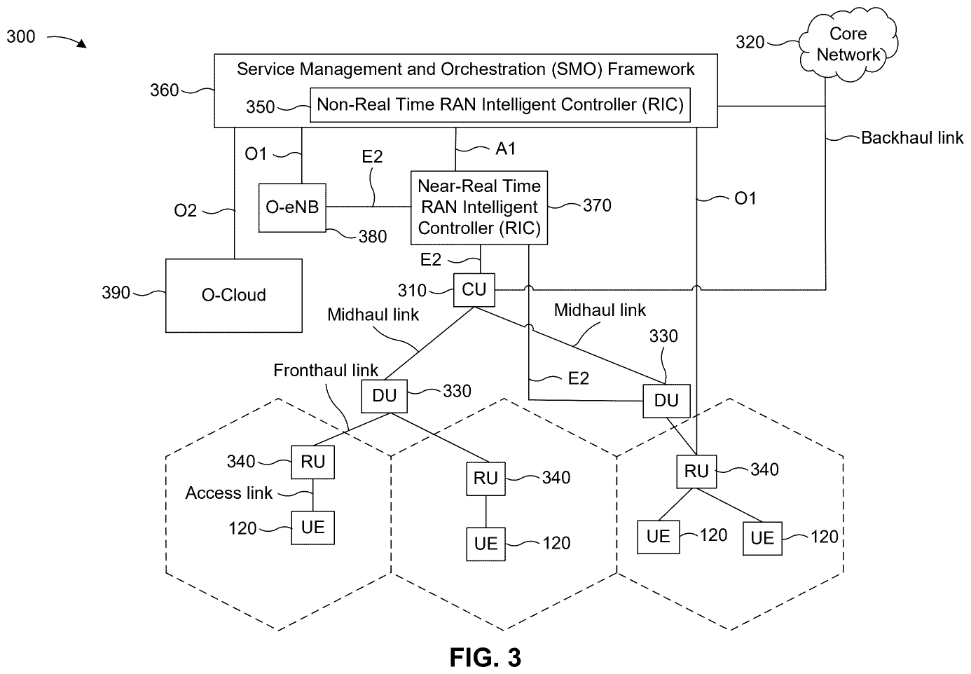

FIG. 3 is a diagram illustrating an example disaggregated base station architecture 300 in accordance with the present disclosure. One or more components of the example disaggregated base station architecture 300 may be, may include, or may be included in one or more network nodes (such one or more network nodes 110). The disaggregated base station architecture 300 may include a CU 310 that can communicate directly with a core network 320 via a backhaul link, or that can communicate indirectly with the core network 320 via one or more disaggregated control units, such as a Non-RT RIC 350 associated with a Service Management and Orchestration (SMO) Framework 360 and/or a Near-RT RIC 370 (for example, via an E2 link). The CU 310 may communicate with one or more DUs 330 via respective midhaul links, such as via F1 interfaces. Each of the DUs 330 may communicate with one or more RUs 340 via respective fronthaul links. Each of the RUs 340 may communicate with one or more UEs 120 via respective RF access links. In some deployments, a UE 120 may be simultaneously served by multiple RUs 340.

Each of the components of the disaggregated base station architecture 300, including the CUs 310, the DUs 330, the RUs 340, the Near-RT RICs 370, the Non-RT RICs 350, and the SMO Framework 360, may include one or more interfaces or may be coupled with one or more interfaces for receiving or transmitting signals, such as data or information, via a wired or wireless transmission medium.

In some aspects, the CU 310 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 310 may be deployed to communicate with one or more DUs 330, as necessary, for network control and signaling. Each DU 330 may correspond to a logical unit that includes one or more base station functions to control the operation of one or more RUs 340. For example, a DU 330 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 330, or for communicating signals with the control functions hosted by the CU 310. Each RU 340 may implement lower layer functionality. In some aspects, real-time and non-real-time aspects of control and user plane communication with the RU(s) 340 may be controlled by the corresponding DU 330.

The SMO Framework 360 may support RAN deployment and provisioning of non-virtualized and virtualized network elements. For non-virtualized network elements, the SMO Framework 360 may support the deployment of dedicated physical resources for RAN coverage requirements, which may be managed via an operations and maintenance interface, such as an O1 interface. For virtualized network elements, the SMO Framework 360 may interact with a cloud computing platform (such as an open cloud (O-Cloud) platform 390) to perform network element life cycle management (such as to instantiate virtualized network elements) via a cloud computing platform interface, such as an O2 interface. A virtualized network element may include, but is not limited to, a CU 310, a DU 330, an RU 340, a non-RT RIC 350, and/or a Near-RT RIC 370. In some aspects, the SMO Framework 360 may communicate with a hardware aspect of a 4G RAN, a 5G NR RAN, and/or a 6G RAN, such as an open eNB (O-eNB) 380, via an O1 interface. Additionally or alternatively, the SMO Framework 360 may communicate directly with each of one or more RUs 340 via a respective O1 interface. In some deployments, this configuration can enable each DU 330 and the CU 310 to be implemented in a cloud-based RAN architecture, such as a vRAN architecture.

The Non-RT RIC 350 may include or may implement a logical function that enables non-real-time control and optimization of RAN elements and resources, AI/ML workflows including model training and updates, and/or policy-based guidance of applications and/or features in the Near-RT RIC 370. The Non-RT RIC 350 may be coupled to or may communicate with (such as via an A1 interface) the Near-RT RIC 370. The Near-RT RIC 370 may include or may implement a logical function that enables near-real-time control and optimization of RAN elements and resources via data collection and actions via an interface (such as via an E2 interface) connecting one or more CUs 310, one or more DUs 330, and/or an O-eNB with the Near-RT RIC 370.

In some aspects, to generate AI/ML models to be deployed in the Near-RT RIC 370, the Non-RT RIC 350 may receive parameters or external enrichment information from external servers. Such information may be utilized by the Near-RT RIC 370 and may be received at the SMO Framework 360 or the Non-RT RIC 350 from non-network data sources or from network functions. In some examples, the Non-RT RIC 350 or the Near-RT RIC 370 may tune RAN behavior or performance. For example, the Non-RT RIC 350 may monitor long-term trends and patterns for performance and may employ AI/ML models to perform corrective actions via the SMO Framework 360 (such as reconfiguration via an O1 interface) or via creation of RAN management policies (such as A1 interface policies).

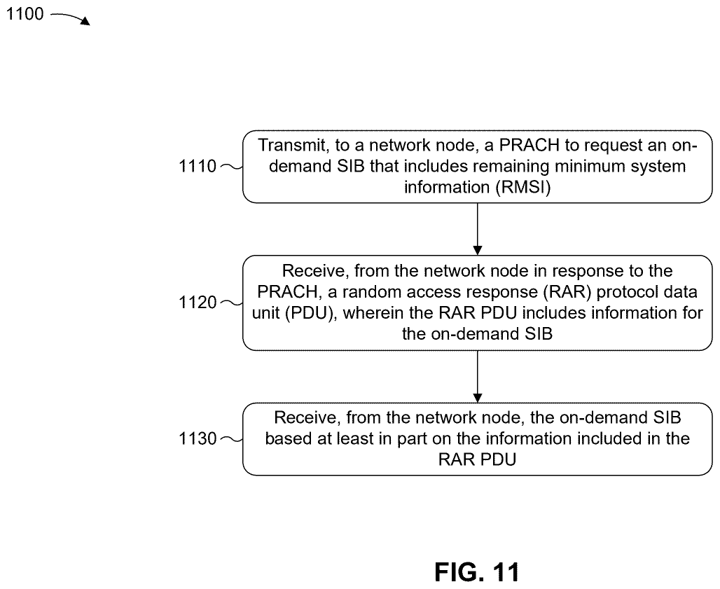

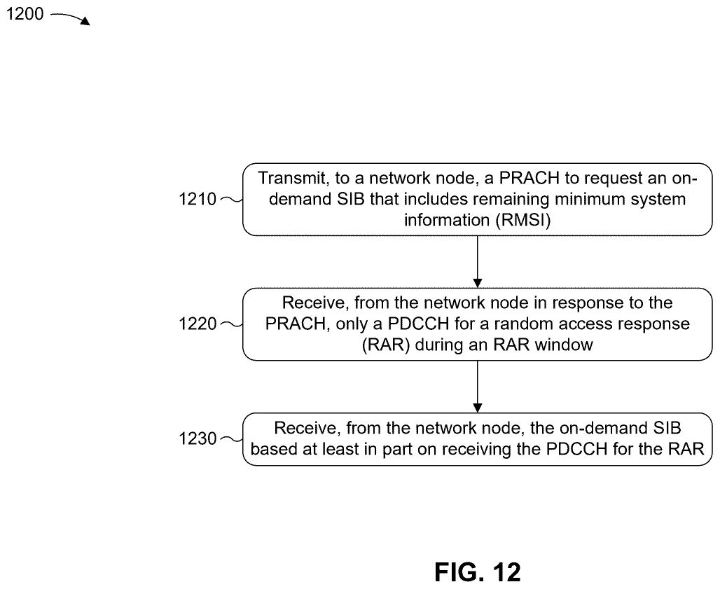

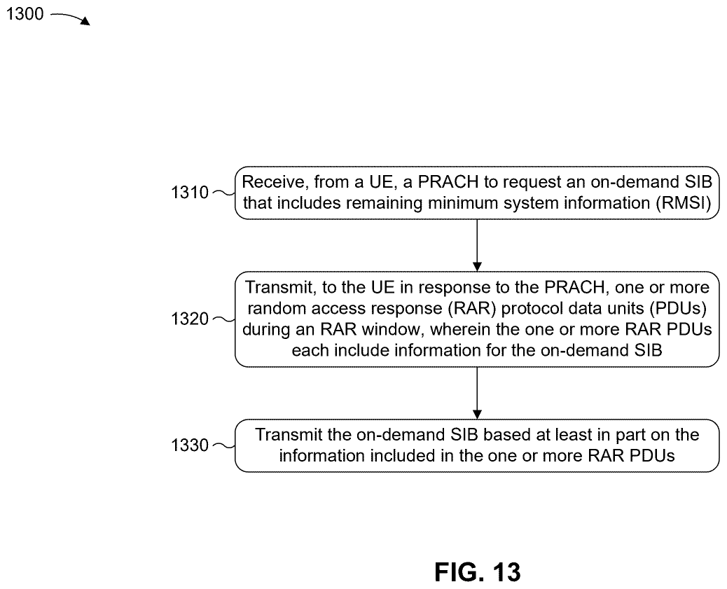

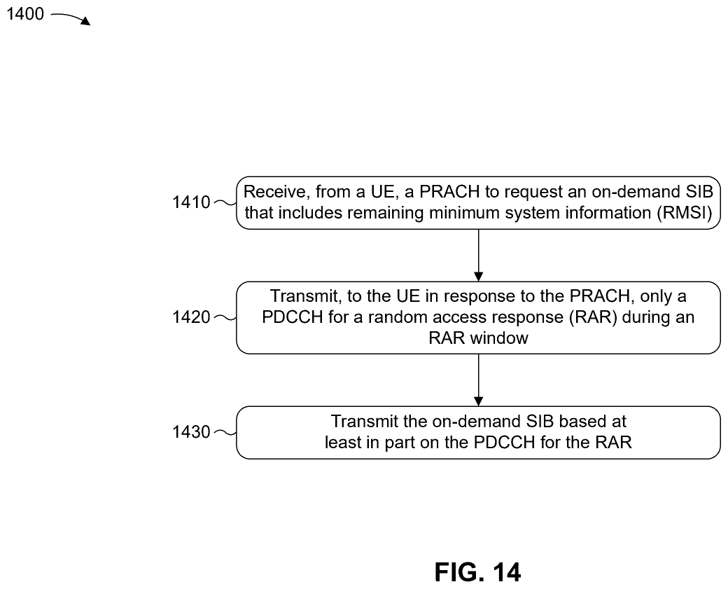

The network node 110, the controller/processor 240 of the network node 110, the UE 120, the controller/processor 280 of the UE 120, the CU 310, the DU 330, the RU 340, or any other component(s) of FIG. 1, 2, or 3 may implement one or more techniques or perform one or more operations associated with an enhanced RAR for an on-demand SIB, as described in more detail elsewhere herein. For example, the controller/processor 240 of the network node 110, the controller/processor 280 of the UE 120, any other component(s) (or combinations of components) of FIG. 2, the CU 310, the DU 330, or the RU 340 may perform or direct operations of, for example, process 1100 of FIG. 11, process 1200 of FIG. 12, process 1300 of FIG. 13, process 1400 of FIG. 14, or other processes as described herein (alone or in conjunction with one or more other processors). The memory 242 may store data and program codes for the network node 110, the network node 110, the CU 310, the DU 330, or the RU 340. The memory 282 may store data and program codes for the UE 120. In some examples, the memory 242 or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 110, the UE 120, the CU 310, the DU 330, or the RU 340, may cause the one or more processors to perform process 1100 of FIG. 11, process 1200 of FIG. 12, process 1300 of FIG. 13, process 1400 of FIG. 14, or other processes as described herein. In some examples, executing instructions may include running the instructions, converting the instructions, compiling the instructions, and/or interpreting the instructions, among other examples.

In some aspects, the UE 120 includes means for transmitting, to a network node 110, a PRACH to request an on-demand SIB that includes RMSI; means for receiving, from the network node 110 in response to the PRACH, an RAR PDU, wherein the RAR PDU includes information for the on-demand SIB; and/or means for receiving, from the network node 110, the on-demand SIB based at least in part on the information included in the RAR PDU. Additionally, or alternatively, in some aspects, the UE 120 includes means for transmitting, to a network node 110, a PRACH to request an on-demand SIB that includes RMSI; means for receiving, from the network node 110 in response to the PRACH, only a PDCCH for an RAR during an RAR window; and/or means for receiving, from the network node 110, the on-demand SIB based at least in part on receiving the PDCCH for the RAR. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for receiving, from a UE 120, a PRACH requesting an on-demand SIB that includes RMSI; means for transmitting, to the UE 120 in response to the PRACH, one or more RAR PDUs during an RAR window, wherein the one or more RAR PDUs each include information for the on-demand SIB; and/or means for transmitting the on-demand SIB based at least in part on the information included in the one or more RAR PDUs. Additionally, or alternatively, in some aspects, the network node 110 includes means for receiving, from a UE 120, a PRACH to request an on-demand SIB that includes RMSI; means for transmitting, to the UE 120 in response to the PRACH, only a PDCCH for an RAR during an RAR window; and/or means for transmitting the on-demand SIB based at least in part on the PDCCH for the RAR. The means for the network node 110 to perform operations described herein may include, for example, one or more of communication manager 150, transmit processor 214, TX MIMO processor 216, modem 232, antenna 234, MIMO detector 236, receive processor 238, controller/processor 240, memory 242, or scheduler 246.

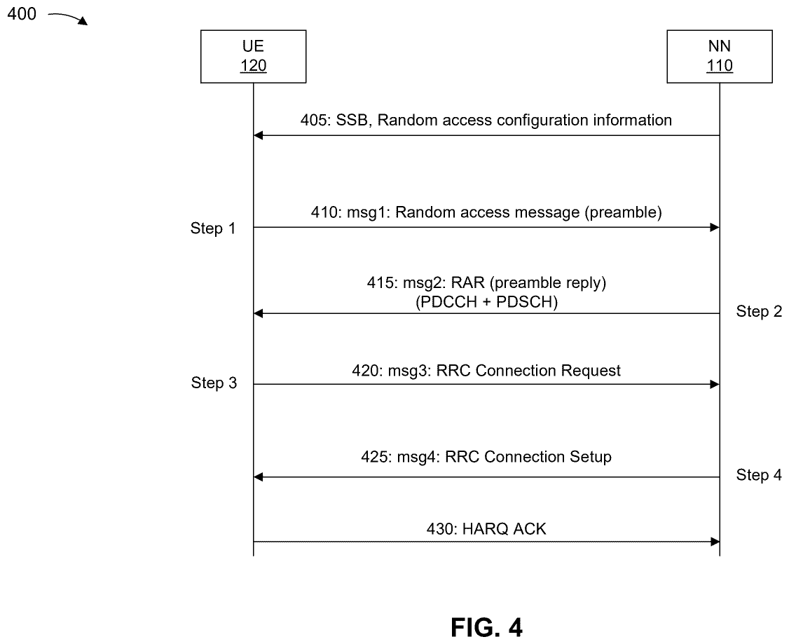

FIG. 4 is a diagram illustrating an example 400 of a four-step random access procedure, in accordance with the present disclosure. As shown in FIG. 4, a network node 110 and a UE 120 may communicate with one another to perform the four-step random access procedure.

As shown by reference number 405, the network node 110 may transmit, and the UE 120 may receive, one or more SSBs and random access configuration information. In some aspects, the random access configuration information may be transmitted in and/or indicated by system information (e.g., in one or more system information blocks (SIBs)) and/or an SSB, such as for contention-based random access. Additionally, or alternatively, the random access configuration information may be transmitted in an RRC message and/or a PDCCH order message that triggers a random access channel (RACH) procedure, such as for contention-free random access. The random access configuration information may include one or more parameters to be used in the random access procedure, such as one or more parameters for transmitting a random access message and/or one or more parameters for receiving an RAR.

As shown by reference number 410, the UE 120 may transmit a random access message, which may include a preamble (sometimes referred to as a random access preamble, a PRACH preamble, or a random access message preamble). The message that includes the preamble may be referred to as a message 1, msg1, MSG1, a first message, or an initial message in a four-step random access procedure. The random access message may include a random access preamble identifier.

As shown by reference number 415, the network node 110 may transmit an RAR as a reply to the preamble. The message that includes the RAR may be referred to as message 2, msg2, MSG2, or a second message in a four-step random access procedure. In some aspects, the RAR may indicate the detected random access preamble identifier (e.g., received from the UE 120 in msg1). Additionally, or alternatively, the RAR may indicate a resource allocation to be used by the UE 120 to transmit message 3 (msg3).

In some aspects, as part of the second step of the four-step random access procedure, the network node 110 may transmit a PDCCH communication for the RAR, also known as or referred to herein as an RAR PDCCH. The PDCCH communication may schedule a PDSCH communication that includes the RAR, also known as or referred to herein as an RAR PDSCH. For example, the PDCCH communication may indicate a resource allocation for the PDSCH communication. Also as part of the second step of the four-step random access procedure, the network node 110 may transmit the RAR PDSCH, as scheduled by the PDCCH communication. The RAR may be included in a MAC PDU of the PDSCH communication, also known as or referred to herein as an RAR PDU.

As shown by reference number 420, the UE 120 may transmit an RRC connection request message. The RRC connection request message may be referred to as message 3, msg3, MSG3, or a third message of a four-step random access procedure. In some aspects, the RRC connection request may include a UE identifier, UCI, and/or a PUSCH communication (e.g., an RRC connection request).

As shown by reference number 425, the network node 110 may transmit an RRC connection setup message. The RRC connection setup message may be referred to as message 4, msg4, MSG4, or a fourth message of a four-step random access procedure. In some aspects, the RRC connection setup message may include the detected UE identifier, a timing advance value, and/or contention resolution information. As shown by reference number 430, if the UE 120 successfully receives the RRC connection setup message, the UE 120 may transmit a HARQ acknowledgement (ACK) to the network node 110.

As indicated above, FIG. 4 is provided as an example. Other examples may differ from what is described with regard to FIG. 4.

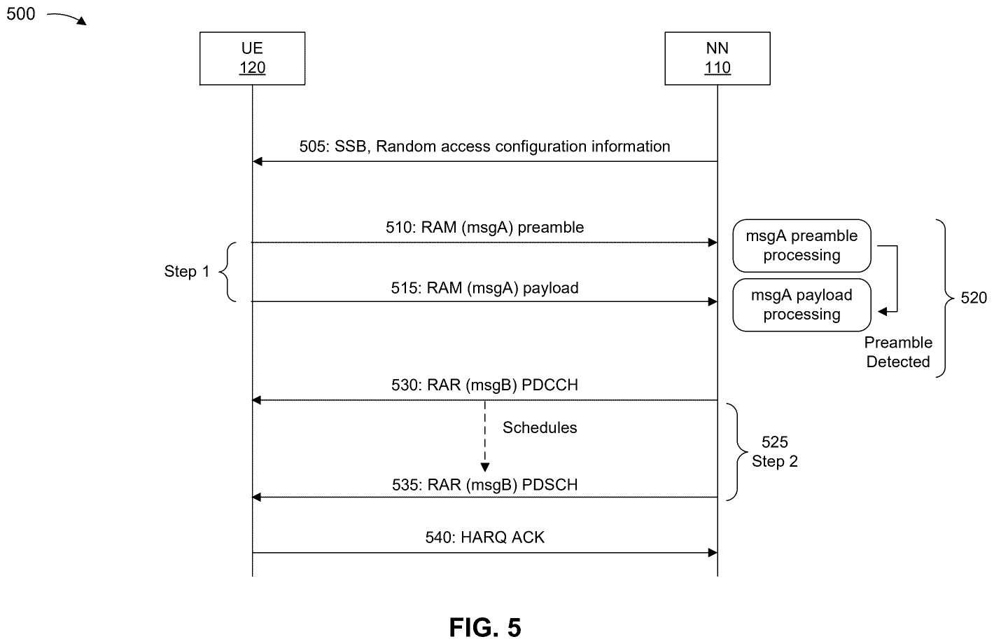

FIG. 5 is a diagram illustrating an example 500 of a two-step random access procedure, in accordance with the present disclosure. As shown in FIG. 5, a network node 110 and a UE 120 may communicate with one another to perform the two-step random access procedure.

As shown by reference number 505, the network node 110 may transmit, and the UE 120 may receive, one or more SSBs and random access configuration information. In some aspects, the random access configuration information may be transmitted in and/or indicated by system information (e.g., in one or more SIBs) and/or an SSB, such as for contention-based random access. Additionally, or alternatively, the random access configuration information may be transmitted in an RRC message and/or a PDCCH order message that triggers a RACH procedure, such as for contention-free random access. The random access configuration information may include one or more parameters to be used in the two-step random access procedure, such as one or more parameters for transmitting a random access message and/or receiving an RAR to the random access message.

As shown by reference number 510, the UE 120 may transmit, and the network node 110 may receive, a random access message preamble. As shown by reference number 515, the UE 120 may transmit, and the network node 110 may receive, a random access message payload. As shown, the UE 120 may transmit the random access message preamble and the random access message payload to the network node 110 as part of an initial (or first) step of the two-step random access procedure. In some aspects, the random access message may be referred to as message A, msgA, a first message, or an initial message in a two-step random access procedure. Furthermore, in some aspects, the random access message preamble may be referred to as a message A preamble, a msgA preamble, a preamble, or a PRACH preamble, and the random access message payload may be referred to as a message A payload, a msgA payload, or a payload. In some aspects, the random access message may include some or all of the contents of message 1 (msg1) and message 3 (msg3) of a four-step random access procedure, which is described in more detail elsewhere herein. For example, the random access message preamble may include some or all contents of message 1 (e.g., a PRACH preamble), and the random access message payload may include some or all contents of message 3 (e.g., a UE identifier, UCI, and/or a PUSCH transmission).

As shown by reference number 520, the network node 110 may receive the random access message preamble transmitted by the UE 120. If the network node 110 successfully receives and decodes the random access message preamble, the network node 110 may then receive and decode the random access message payload.

As shown by reference number 525, the network node 110 may transmit an RAR (sometimes referred to as an RAR message). As shown, the network node 110 may transmit the RAR message as part of a second step of the two-step random access procedure. In some aspects, the RAR message may be referred to as message B, msgB, or a second message in a two-step random access procedure. The RAR message may include some or all of the contents of message 2 (msg2) and message 4 (msg4) of a four-step random access procedure. For example, the RAR message may include the detected PRACH preamble identifier, the detected UE identifier, a timing advance value, and/or contention resolution information.

As shown by reference number 530, as part of the second step of the two-step random access procedure, the network node 110 may transmit a PDCCH communication for the RAR. The PDCCH communication for the RAR may schedule a PDSCH communication that includes the RAR. For example, the PDCCH for the RAR communication may indicate a resource allocation (e.g., in DCI) for the PDSCH communication that includes the RAR.

As shown by reference number 535, as part of the second step of the two-step random access procedure, the network node 110 may transmit the PDSCH communication for the RAR, as scheduled by the PDCCH communication for the RAR. The RAR may be included in a MAC PDU of the RAR PDSCH communication. As shown by reference number 540, if the UE 120 successfully receives the RAR, the UE 120 may transmit a HARQ ACK to the network node 110.

As indicated above, FIG. 5 is provided as an example. Other examples may differ from what is described with regard to FIG. 5.

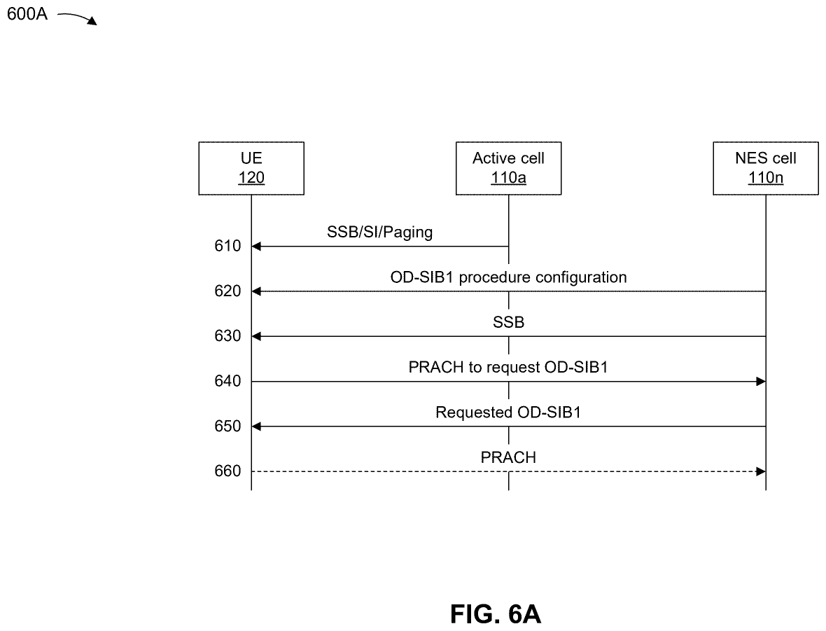

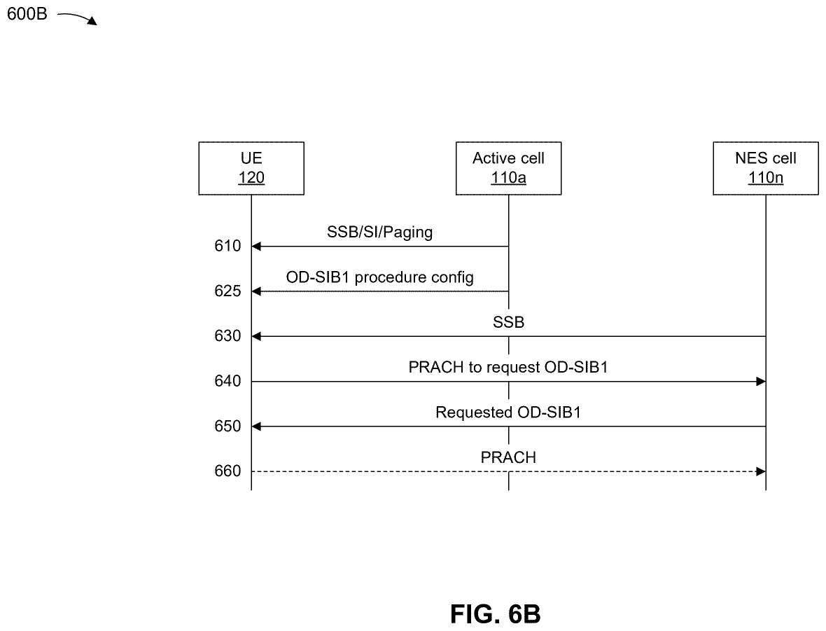

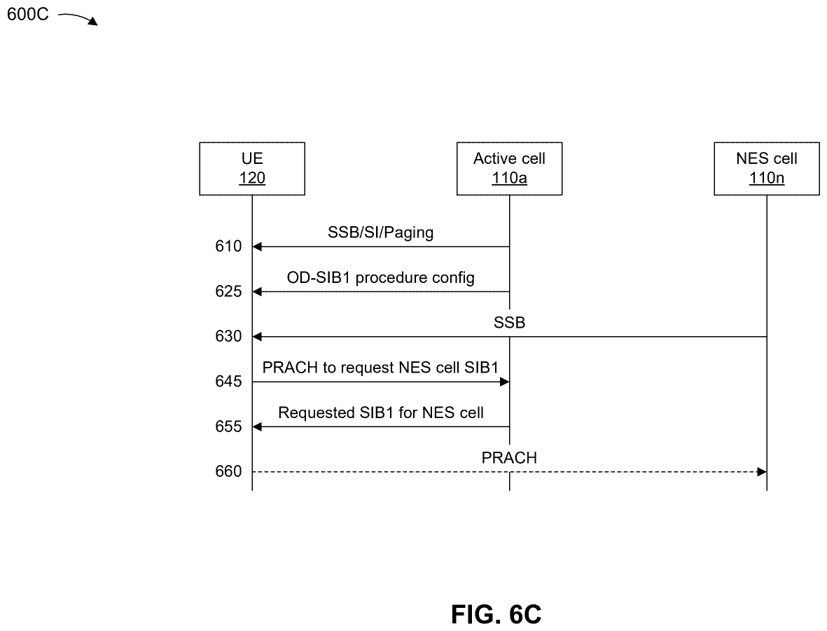

FIGS. 6A-6C are diagrams illustrating examples 600A-600C associated with on-demand SIB, in accordance with the present disclosure. As shown in FIGS. 6A-6C, examples 600A-600C include communication between a UE 120, an active cell 110a, and an NES cell 110n. For example, as described herein, the active cell 110a is a cell that periodically transmits at least a SIB1 associated with the active cell 110a, and the NES cell 110n is a cell that may transmit a SIB1 in an on-demand manner, in response to an UL-WUS from the UE 120.

More particularly, as described herein, one technique to increase energy efficiency in a RAN is to enable “on-demand” broadcast transmissions by a network node and/or a cell. For example, to reduce power consumption at a network node, the network node may transmit certain broadcast communications (e.g., system information communications, SSBs, and/or SIBs) in an on-demand manner (e.g., upon request, rather than on a periodic basis or following a periodic schedule). In some examples, an on-demand communication may be a communication that carries RMSI, such as SIB1. In some examples, an SSB and/or SIB1 may include information to support initial access, measurement, camping, and/or cell selection or reselection by the UE 120. Typically, such communications are periodically broadcasted (e.g., following a periodic schedule where the communication(s) are transmitted one or more times, and often beamswept in multiple beam directions, in each period) so that the UE 120 can receive the communications in an idle and/or inactive state and/or upon moving into a geographic region of the NES cell 110n and establish a connection with the NES cell 110n. Therefore, one way to reduce network power consumption is to reduce transmissions of such communications such that, for example, an SSB and/or SIB1 is transmitted less frequently by a cell operating in an NES mode (or NES state).

For example, the NES cell 110n may operate in an NES mode or an NES state associated with an on-demand SIB1, where the SIB1 is transmitted only upon request by the UE 120, in order to reduce overhead and/or reduce power consumption. For example, the NES cell 110n may operate in the NES mode or the NES state associated with the on-demand SIB1 during periods with low activity (e.g., there are few UEs 120 entering and exiting the coverage of the cell, or there are not many UEs 120 that are attempting to establish a connection), in which case periodically broadcasting SIB1 (e.g., every 20 or 160 milliseconds) may be wasteful. In such cases, the SIB1 associated with the NES cell 110n may be broadcast only on-demand, or only upon request by the UE 120, where the request may be carried in an UL-WUS.

For example, as shown in FIG. 6A, and by reference number 610, the active cell 110a may transmit, and the UE 120 may receive, one or more SSBs, one or more system information messages, and/or one or more paging messages with the active cell 110a (e.g., to acquire a SIB1 associated with the active cell 110a). Furthermore, as shown by reference number 620 in FIG. 6A, the NES cell 110n may transmit, and the UE 120 may receive, a message that indicates an on-demand SIB1 procedure configuration (e.g., indicating one or more parameters for requesting and acquiring the on-demand SIB1 associated with the NES cell 110n). For example, in some aspects, the on-demand SIB1 procedure configuration may include an UL-WUS configuration, where the UL-WUS may be configured as a PRACH that includes a dedicated preamble reserved to requesting the on-demand SIB1 (e.g., distinct from PRACH preambles for the purpose of initial access). Accordingly, when the UE 120 detects and acquires an SSB from the NES cell 110n, as shown by reference number 630, the UE 120 may use the information in the on-demand SIB1 procedure configuration to request the on-demand SIB1 associated with the NES cell 110n. For example, as shown by reference number 640, the UE 120 may transmit a PRACH to request the on-demand SIB1 to the NES cell 110n. As shown by reference number 650 in FIG. 6A, the NES cell 110n may then transmit the on-demand SIB1 in response to the PRACH transmitted by the UE 120. As shown by reference number 660, the UE 120 may then transmit a second PRACH to the NES cell 110n that includes a preamble associated with requesting initial access to the NES cell 110n (e.g., to enter a connected mode on the NES cell 110n).

In example 600A, the NES cell 110n acts as a source cell for providing the UL-WUS configuration to the UE 120 (e.g., in the on-demand SIB1 procedure configuration), a target cell for receiving the UL-WUS transmission from the UE 120 (e.g., in the PRACH to request the on-demand SIB1 associated with the NES cell 110n), and as the source cell for transmitting the on-demand SIB1. Accordingly, in example 600A, the active cell 110a periodically transmits the SSB, system information, and paging messages associated with the active cell 110a and does not act as a source cell or a target cell for any messages that relate to the on-demand SIB1 associated with the NES cell 110n.

Alternatively, in example 600B shown in FIG. 6B, the active cell 110a acts as the source cell for providing the UL-WUS configuration associated with the NES cell 110n to the UE 120. For example, as shown by reference number 625 in FIG. 6B, the active cell 110a may transmit the on-demand SIB1 procedure configuration to the UE 120, and other messages associated with requesting and acquiring the on-demand SIB1 associated with the NES cell 110n are the same as example 600A (e.g., where the NES cell 110n acts as the target cell for receiving the UL-WUS transmission from the UE 120 and as the source cell for transmitting the on-demand SIB1. In this way, relative to example 600A, the NES cell 110n may conserve energy by not transmitting the on-demand SIB1 procedure configuration indicating the UL-WUS configuration.

Alternatively, in example 600C shown in FIG. 6C, the active cell 110a acts as the source cell for providing the UL-WUS configuration associated with the NES cell 110n to the UE 120, as the target cell for receiving the UL-WUS transmission from the UE 120, and as the source cell for transmitting the on-demand SIB1 associated with the NES cell 110n. For example, as shown by reference number 645 in FIG. 6C, the UE 120 may transmit the PRACH to request the on-demand SIB1 associated with the NES cell 110n to the active cell 110a. Furthermore, as shown by reference number 655, the active cell 110a may transmit the on-demand SIB1 associated with the NES cell 110n to the UE 120, and other messages associated with requesting and acquiring the on-demand SIB1 associated with the NES cell 110n are the same as example 600B (e.g., where the active cell 110a provides the on-demand SIB1 procedure configuration). In this way, relative to example 600B, the NES cell 110n may conserve energy by not having to monitor and/or process a PRACH transmission requesting the on-demand SIB1 and by not having to transmit the on-demand SIB1 that the UE 120 uses to request initial access.

As indicated above, FIGS. 6A-6C are provided as examples. Other examples may differ from what is described with regard to FIGS. 6A-6C.

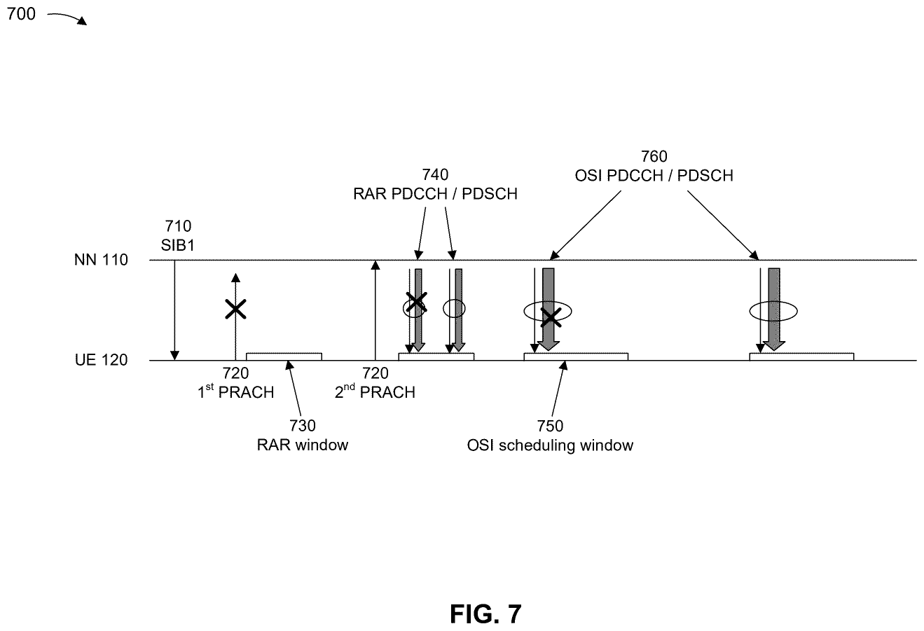

FIG. 7 is a diagram illustrating an example 700 associated with on-demand other system information (OSI), in accordance with the present disclosure. As shown in FIG. 7, example 700 includes communication between a UE 120 and a network node 110. For example, as described herein, the network node 110 is a cell that transmits OSI, which includes system information other than RMSI indicated in SIB1, on-demand and only in response to a request for the OSI. Accordingly, example 700 illustrates techniques for the UE 120 to request and acquire the on-demand OSI according to a msg1-based request. Alternatively, although not shown in FIG. 7, the network node 110 may be configured to provision the on-demand OSI according to a msg3-based request, using an RRC message (e.g., an RRCSystemInfoRequest message).

For example, as shown in FIG. 7, the network node 110 may transmit SIB1 710, which generally includes RMSI for acquiring initial access to (e.g., entering a connected mode on) a cell provided by the network node 110. Furthermore, rather than periodically broadcasting SIBs or other messages that contain system information other than RMSI that is included in SIB1, the SIB1 710 transmitted by the network node 110 may indicate a configuration for a msg1-based system information request (or msg1-based on-demand OSI request). For example, the configuration for the msg1-based system information request may include PRACH resources (e.g., a preamble and occasion mask for a PRACH occasion) for requesting the on-demand OSI and/or scheduling information for the on-demand OSI.

As further shown in FIG. 7, the UE 120 may transmit a PRACH 720 to the network node 110 to request the on-demand OSI. For example, the PRACH 720 may be transmitted using the PRACH resources (e.g., the preamble and occasion mask) that are indicated in the SIB1 710 for requesting the on-demand OSI (e.g., distinct from a preamble and/or PRACH occasion that may be used to request initial access to the network node 110). The UE 120 may then monitor for an RAR from the network node 110 during an RAR window 730. For example, the RAR window 730 generally starts at an earliest control resource set (CORESET) associated with a zero index (CORESET0) that is at least one symbol after transmission of the PRACH 720, and the RAR window 730 has a duration that is configured in the SIB1 710 (e.g., 1, 2, 4, 8, 10, 20, 40, or 80 slots, and constrained to not exceed 10 milliseconds). Within the RAR window 730, the UE may monitor a Type 1 PDCCH common search space (CSS) (e.g., a random access search space) according to a periodicity that is configured in SIB1 710 (e.g., according to a slot or a mini-slot granularity). However, in some cases, the network node 110 may not transmit the RAR during the RAR window 730. For example, as shown in FIG. 7, the network node 110 may not receive and/or may not detect the PRACH 720 transmitted by the UE 120. Accordingly, as shown in FIG. 7, the UE 120 may retransmit the PRACH 720 one or more times (e.g., using a power ramping rule) in cases where the RAR is not detected during the RAR window 730.

As further shown in FIG. 7, upon detecting the PRACH 720 transmitted by the UE 120 to request the on-demand OSI, the network node 110 may transmit an RAR 740 during the RAR window 730. For example, as described herein, the RAR 740 may generally include a PDCCH for the RAR 740 and a PDSCH for the RAR 740, where the RAR PDCCH includes scheduling information for the RAR PDSCH. The PDSCH may include the RAR 740 within an RAR PDU. For example, as described herein, an RAR PDU generally includes one or more RAR subPDUs, where each RAR subPDU includes a MAC subheader (e.g., with a backoff indicator only, a random access preamble identifier (RAPID) only, or a RAPID and a MAC RAR) and a MAC service data unit (SDU). Furthermore, in some cases, the network node 110 may transmit the RAR 740 multiple times during the RAR window 730 for improved reliability. For example, in the scenario shown in FIG. 7, the UE 120 does not receive the first PDCCH and PDSCH that the network node 110 transmits for the RAR 740. However, because the network node 110 transmits the RAR 740 multiple times during the RAR window 730, the UE 120 is able to detect and successfully decode the second transmission of the RAR 740. Upon successful reception of the RAR 740, the UE 120 may then monitor for the on-demand OSI during an OSI scheduling window 750. For example, as shown, the network node 110 may transmit a PDCCH for the on-demand OSI, which may schedule a PDSCH that includes the on-demand OSI (collectively shown as an OSI PDCCH/PDSCH 760). Furthermore, for improved reliability, the network node 110 may transmit the OSI PDCCH/PDSCH 760 multiple times during the OSI scheduling window 750. Accordingly, the UE 120 may monitor for the OSI PDCCH/PDSCH 760 during the OSI scheduling window 750 until the OSI PDCCH/PDSCH 760 is successfully received within a modification period.

As described herein, example 700 illustrates techniques for the UE 120 to request and acquire the on-demand OSI according to a msg1-based request. Accordingly, in some aspects, similar techniques may be used to enable a prioritized (e.g., contention-free) msg1-based RACH procedure where an UL-WUS for requesting an on-demand SIB1 may be configured as a PRACH that is transmitted using a dedicated PRACH resource. For example, in a msg1-based RACH procedure for requesting an on-demand SIB1, a UE 120 may transmit a PRACH preamble using the dedicated PRACH resource, and may monitor for the on-demand SIB1 upon successful reception of an RAR. Alternatively, the on-demand SIB1 may be requested using a msg3-based RACH procedure (e.g., contention-based or contention-free), where the on-demand SIB1 is acquired based on successful transmission and reception of a PRACH preamble and an RAR followed by a msg3 and ms4 for contention resolution.

As indicated above, FIG. 7 is provided as an example. Other examples may differ from what is described with regard to FIG. 7.

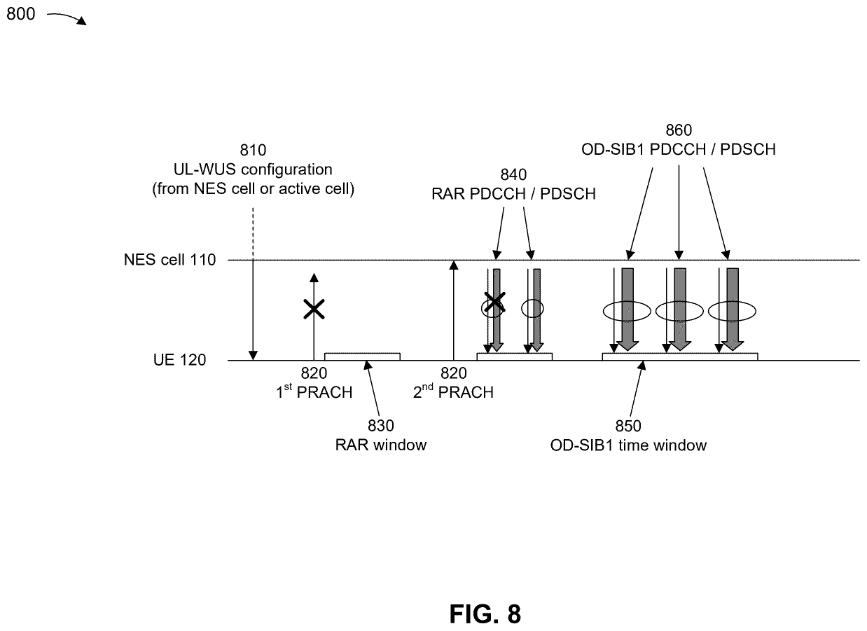

FIG. 8 is a diagram illustrating an example 800 associated with a random access procedure for requesting an on-demand SIB, in accordance with the present disclosure. As shown in FIG. 8, example 800 includes communication between a UE 120 and a network node 110. For example, as described herein, the network node 110 provides a cell in which a SIB1 that includes RMSI is transmitted on-demand for network energy savings, and may be referred to herein as an NES cell 110. As described herein, example 800 illustrates techniques for the UE 120 to request and acquire the on-demand OSI according to a msg1-based request. Alternatively, although not shown in FIG. 8, the NES cell 110 may be configured to provision the on-demand SIB1 according to a msg3-based request. In example 800, the UE 120 may generally follow steps associated with a typical contention-free random access procedure to transmit and/or retransmit a PRACH and monitor an RAR window to receive an RAR (e.g., as described with reference to FIGS. 4-5).

For example, as shown in FIG. 8, the UE 120 may receive an UL-WUS configuration 810 for the NES cell 110, where the UL-WUS configuration 810 may be received from the NES cell 110 or an active cell (e.g., as described above with reference to FIGS. 6A-6C). In some aspects, the UL-WUS may include dedicated PRACH resources (e.g., a dedicated preamble and occasion mask for a PRACH occasion) for requesting the on-demand SIB1 and/or scheduling information for the on-demand SIB1.

As further shown in FIG. 8, the UE 120 may transmit a PRACH 820 to the NES cell 110 to request the on-demand OSI. For example, the PRACH 820 may be transmitted using the PRACH resources (e.g., the preamble and occasion mask) that are indicated in the UL-WUS configuration 810 for requesting the on-demand SIB1 (e.g., distinct from a preamble and/or PRACH occasion that may be used to request on-demand OSI and/or initial access to the NES cell 110). The UE 120 may then monitor for an RAR from the NES cell 110 during an RAR window 830. For example, the RAR window 830 generally starts at an earliest CORESET0 that is at least one symbol after transmission of the PRACH 820, and the RAR window 830 has a duration that is configured in the UL-WUS configuration 810. Within the RAR window 830, the UE may monitor a Type 1 PDCCH CSS (e.g., a random access search space) according to a periodicity that is configured in the UL-WUS configuration 810. Furthermore, as described herein, the UE 120 may retransmit the PRACH 820 one or more times (e.g., using a power ramping rule) in cases where the RAR is not detected during the RAR window 830.

As further shown in FIG. 8, upon detecting the PRACH 820 transmitted by the UE 120 to request the on-demand SIB1, the NES cell 110 may transmit an RAR 840 during the RAR window 830. For example, as described herein, the RAR 840 may generally include a PDCCH for the RAR 840 and a PDSCH for the RAR 840, where the RAR PDCCH includes scheduling information for the RAR PDSCH. The PDSCH may include the RAR 840 within an RAR PDU. For example, as described herein, an RAR PDU generally includes one or more RAR subPDUs, where each RAR subPDU includes a MAC subheader and a MAC SDU. Furthermore, in some cases, the NES cell 110 may transmit the RAR 840 multiple times during the RAR window 830 for improved reliability. For example, each transmission of the RAR 840 may include a PDCCH for the RAR 840 and a PDSCH for the RAR 840, where the PDCCH for the RAR 840 schedules the PDSCH for the RAR 840.

As further shown in FIG. 8, upon successful reception of the RAR 840 within the RAR window 830, the UE 120 may monitor, during a time window 850 configured for on-demand SIB1 transmission, for a PDCCH and PDSCH 860 for the on-demand SIB1. For example, in some aspects, the time window 850 for on-demand SIB1 transmission may be defined according to a set of parameters that may include a starting offset and a duration corresponding to a number of slots or other time period. In some aspects, the starting offset of the time window 850 for on-demand SIB1 transmission may be relative to a reference occasion related to the RAR window 830 in which the RAR 840 was received by the UE 120 (e.g., a start or an end of the RAR window 830 in which the RAR 840 was received by the UE 120). Alternatively, the starting offset of the time window 850 may be relative to a specific PDCCH monitoring occasion for the RAR 840 within the RAR window 830 (e.g., a first, last, or nth PDCCH occasion within the RAR window 830, or a PDCCH occasion for the PDCCH that scheduled the PDSCH carrying the RAR 840 received by the UE 120) or a PRACH occasion associated with the RAR window 830 (e.g., a PRACH occasion in which the UE 120 transmitted the PRACH 820 to request the on-demand SIB1).

Furthermore, as described herein, the UE 120 may monitor a PDCCH during the time window 850 according to a CORESET and search space that may be indicated in one or more signaling messages. For example, in some aspects, the CORESET and search space to be monitored during the time window 850 may be indicated in a similar manner as a cell that transmits a periodic SIB1 (e.g., via a master information block (MIB)), or the CORESET and search space to be monitored during the time window 850 may be indicated by the UL-WUS configuration 810 (e.g., to enable a PDCCH monitoring periodicity for the on-demand SIB1 shorter than 20 ms, which is the default value for a periodic SIB1, to reduce acquisition latency for the on-demand SIB1).

As described herein, when the UE 120 uses the techniques shown in example 800 to request and acquire the on-demand SIB1, which may be referred to herein as a baseline transmission scheme for on-demand SIB1, there are several downlink signaling messages between the PRACH 820 and the PDSCH that includes the on-demand SIB1. In particular, the NES cell 110 transmits a PDCCH for the RAR 840 (e.g., with DCI format 1_0 with a cyclic redundancy code (CRC) scrambled by a random access radio network temporary identity (RA-RNTI) for scheduling the RAR 840), a PDSCH for the RAR 840 (e.g., carrying an RAR PDU that includes one or more RAR subPDUs to respond to one or more UEs 120 transmitting a PRACH 820 in a PRACH occasion corresponding to the RA-RNTI used to scramble the CRC of the DCI with format 1_0), and a PDCCH for the on-demand SIB1 (e.g., with DCI format 1_0 with a CRC scrambled by a system information radio network temporary identity (SI-RNTI) for scheduling the on-demand SIB1). As a result, the baseline transmission scheme for on-demand SIB1 can increase energy consumption by the NES cell 110 and/or increase latency for acquiring the on-demand SIB1. Furthermore, the number of uplink transmissions may be increased in cases where the NES cell 110 does not detect one or more transmissions of a PRACH 820 requesting the on-demand SIB1, and the number of downlink transmissions may be increased in cases where the UE 120 does not detect one or more transmissions of an RAR 840 during the RAR window 830 or the on-demand SIB1 during the time window 850.

As indicated above, FIG. 8 is provided as an example. Other examples may differ from what is described with regard to FIG. 8.

Various aspects relate generally to an enhanced RAR for an on-demand SIB1. Some aspects more specifically relate to consolidating downlink signaling messages between a PRACH transmission requesting an on-demand SIB1 and a PDSCH that includes the on-demand SIB1 in order to increase network energy savings and/or reduce latency associated with acquiring the on-demand SIB1. For example, in some aspects, a target cell 110 that receives a PRACH requesting an on-demand SIB1 may transmit, to the UE 120 requesting the on-demand SIB1 during an RAR window, an RAR PDCCH that schedules an RAR PDSCH that includes an enhanced RAR protocol data unit (PDU). For example, the enhanced RAR PDU may include full or partial scheduling information for the PDSCH that includes the on-demand SIB1, whereby the network node may drop (e.g., not transmit) the PDCCH scheduling the PDSCH that includes the on-demand SIB1. In this way, the enhanced RAR PDU may increase energy savings for the UE 120 and the network node (e.g., because the network node does not transmit the PDCCH for the on-demand SIB1, and the UE 120 does not have to monitor for or decode the PDCCH for the on-demand SIB1) and/or enable a higher reliability for the on-demand SIB1. Additionally, or alternatively, in some aspects, the target cell 110 that receives the PRACH requesting the on-demand SIB1 may transmit, to the UE 120 requesting the on-demand SIB1 during an RAR window, an enhanced RAR PDCCH that indicates the dedicated preamble for requesting the on-demand SIB1 as an acknowledgement for reception of the PRACH. Accordingly, the network node may then drop (e.g., not transmit) the PDSCH for the RAR. In some aspects, the enhanced PDCCH may further include scheduling information for the PDSCH that includes the on-demand SIB1, in which case the network node may drop (e.g., not transmit) the PDSCH for the RAR in addition to the PDCCH scheduling the on-demand SIB1. In this way, in addition to conserving energy that would otherwise be consumed transmitting and/or receiving the RAR PDSCH and/or the PDCCH for the on-demand SIB1, indicating dynamic scheduling information for the on-demand SIB1 within the enhanced RAR PDCCH may result in a lower failure rate because the UE 120 does not have to detect and decode the RAR PDSCH to obtain the scheduling information.

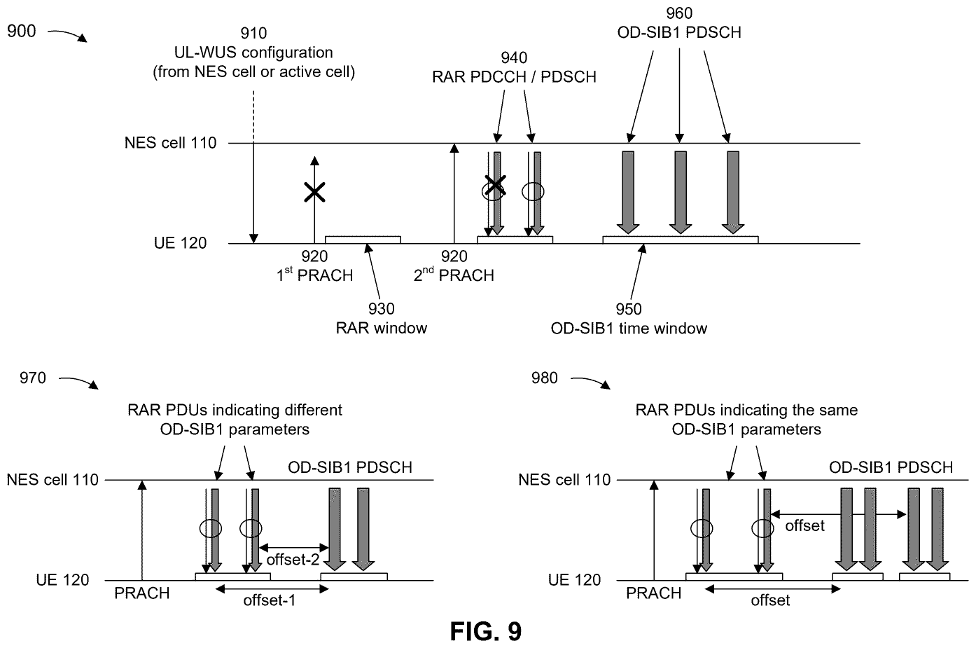

FIG. 9 is a diagram illustrating an example 900 associated with an enhanced RAR for an on-demand SIB, in accordance with the present disclosure. As shown in FIG. 9, example 900 includes communication between a UE 120 and a network node 110. For example, as described herein, the network node 110 provides a cell in which a SIB1 that includes RMSI is transmitted on-demand for network energy savings, and may be referred to herein as an NES cell 110. As described herein, example 900 illustrates techniques for the UE 120 to request and acquire the on-demand SIB1 according to a msg1-based request. Alternatively, although not shown in FIG. 8, the NES cell 110 may be configured to provision the on-demand SIB1 according to a msg3-based request. In example 800, the UE 120 may generally follow steps associated with a typical contention-free random access procedure to transmit and/or retransmit a PRACH and monitor an RAR window to receive an RAR (e.g., as described with reference to FIGS. 4-5).

For example, as shown in FIG. 9, the UE 120 may receive an UL-WUS configuration 910 for the NES cell 110, where the UL-WUS configuration 910 may be received from the NES cell 110 or an active cell (e.g., as described above with reference to FIGS. 6A-6C). In some aspects, the UL-WUS configuration 910 may include dedicated PRACH resources (e.g., a dedicated preamble and occasion mask for a PRACH occasion) for requesting the on-demand SIB1. In some aspects, as described herein, the UL-WUS configuration may include partial scheduling information for the on-demand SIB1.

As further shown in FIG. 9, the UE 120 may transmit a PRACH 920 to the NES cell 110 to request the on-demand SIB1. For example, the PRACH 920 may be transmitted using the PRACH resources (e.g., the preamble and occasion mask) that are indicated in the UL-WUS configuration 910 for requesting the on-demand SIB1 (e.g., distinct from a preamble and/or PRACH occasion that may be used to request on-demand OSI and/or initial access to the NES cell 110). The UE 120 may then monitor for an RAR 940 from the NES cell 110 during an RAR window 930. Within the RAR window 930, the UE may monitor a PDCCH CSS according to a periodicity that is indicated in the UL-WUS configuration 910. Furthermore, as described herein, the UE 120 may retransmit the PRACH 920 one or more times (e.g., using a power ramping rule) in cases where the RAR is not detected during the RAR window 930.

As further shown in FIG. 9, upon detecting the PRACH 920 transmitted by the UE 120 to request the on-demand SIB1, the NES cell 110 may transmit an RAR 940 during the RAR window 930. For example, as described herein, the RAR 940 may generally include a PDCCH for the RAR 940 and a PDSCH for the RAR 940, where the PDCCH for the RAR 940 includes scheduling information for the RAR PDSCH. For example, in some aspects, the PDCCH for the RAR 940 may include DCI with a CRC scrambled by an RA-RNTI, and may indicate a frequency domain resource assignment (FDRA), a time domain resource assignment (TDRA), a virtual resource block (VRB) to physical resource block (PRB) mapping, an MCS, and a TB scaling parameter for the RAR 940. Furthermore, in some aspects, the PDSCH for the RAR 940 may include an enhanced RAR PDU that includes scheduling information for the on-demand SIB1. Accordingly, upon successful reception of the RAR 940 that includes the enhanced RAR PDU within the RAR window 930, the UE 120 may receive, during a time window 950 configured for on-demand SIB1 transmission, a PDSCH 960 that includes the on-demand SIB1 based at least in part on the scheduling information included in the enhanced RAR PDU. In this way, the NES cell 110 does not transmit any PDCCH that indicates scheduling parameters for the PDSCH 960 that includes the on-demand SIB1, which may increase energy savings for the NES cell 110 and the UE 120 relative to the baseline transmission scheme described in example 800. Furthermore, because the PDCCH for the on-demand SIB1 is not transmitted, a higher reliability can be achieved for the on-demand SIB1. For example, in an SSB-SIB1 multiplexing pattern where SIB1 is frequency division multiplexed (FDMed) with an SSB over four symbols, the PDSCH 960 for the on-demand SIB1 alone can span (e.g., occupy) four symbols, which may enable a lower code rate for the on-demand SIB1 relative to the baseline transmission scheme described in example 800. For example, in SSB-SIB1 multiplexing pattern 3, both the PDCCH and the PDSCH for SIB1 are typically FDMed with an SSB that occupies four symbols, such that the total number of symbols (including both the PDCCH and the PDSCH) for SIB1 is less than or equal to four. In contrast, because the enhanced RAR PDU enables the PDCCH with the scheduling DCI for the on-demand SIB1 to be dropped, the PDSCH for the on-demand SIB1 can span the entire four symbols, resulting in higher reception reliability at least for SSB-SIB1 multiplexing pattern 3.

Accordingly, because the enhanced RAR PDU (included in the PDSCH for the RAR 940) includes full or partial scheduling information for the on-demand SIB1, the NES cell 110 does not need to transmit a separate PDCCH to schedule the on-demand SIB1 during the time window 950 configured for on-demand SIB1 transmission. For example, in some aspects, the enhanced RAR PDU may include a MAC subPDU for the on-demand SIB1, where the MAC subPDU for the on-demand SIB1 may include a MAC subheader and a MAC RAR SDU. For example, the MAC subheader may include an extension field, a type field, and a RAPID, and the MAC RAR SDU within the MAC subPDU may include full or partial scheduling parameters for the on-demand SIB1. For example, DCI format 1_0 with a CRC scrambled by an SI-RNTI is typically used to schedule SIB1 and other SIB messages. Accordingly, in some aspects, the MAC RAR SDU within the MAC subPDU of the enhanced RAR PDU may indicate a full set of scheduling parameters for the on-demand SIB1 (e.g., all parameters associated with DCI format 1_0 with a CRC scrambled by an SI-RNTI), such as an FDRA, a TDRA, a VRB-to-PRB mapping, an MCS, a redundancy version (RV), and a system information indicator (e.g., set to 0 to indicate the on-demand SIB1). Alternatively, in some aspects, the MAC RAR SDU within the MAC subPDU of the enhanced RAR PDU may indicate a partial set of scheduling parameters for the on-demand SIB1 (e.g., an FDRA, TDRA, and system information indicator), and any remaining scheduling parameters for the on-demand SIB1 (e.g., a VRB-to-PRB mapping, MCS, and RV) may be fixed or otherwise defined in a wireless communication standard and/or indicated in the UL-WUS configuration 910.

In some aspects, as described herein, the NES cell 110 may transmit the PDSCH 960 that includes the on-demand SIB1 multiple times for improved reliability. For example, in some aspects, the NES cell 110 may transmit a number of consecutive PDSCHs 960 (e.g., bundled PDSCHs 960) that include the on-demand SIB1, similar to an aggregation factor used for PDSCH repetition. In such cases, a starting slot offset for a first PDSCH 960 that includes the on-demand SIB1 may be indicated in the enhanced RAR PDU (e.g., in the MAC RAR SDU of the MAC subPDU for the on-demand SIB1). Alternatively, in some aspects, the starting slot offset for a first PDSCH 960 that includes the on-demand SIB1 may be fixed or otherwise defined in a wireless communication standard and/or indicated in the UL-WUS configuration 910. Furthermore, in cases, where the enhanced RAR PDU indicates an RV associated with the PDSCH 960 for the on-demand SIB1, the RV indicated in the enhanced RAR PDU may be for a first PDSCH 960 that includes the on-demand SIB1 within the time window 950 configured for on-demand SIB1 transmission. In this case, RVs for remaining PDSCHs 960 that include the on-demand SIB1 may be defined according to one or more rules that are fixed or otherwise defined in a wireless communication standard (e.g., a cyclic shifted version of a pattern starting with the indicated RV).

In some aspects, upon successfully receiving the PRACH 920 from the UE 120 requesting the on-demand SIB1, the NES cell 110 may transmit multiple enhanced RAR PDUs that include full or partial scheduling information for the on-demand SIB1 within the RAR window 930. For example, HARQ combining across different RAR PDUs is generally not supported at the UE 120, whereby transmitting multiple enhanced RAR PDUs within the RAR window 930 may increase reception reliability for the RAR 940 at the UE 120. Accordingly, in some aspects, different RAR PDUs that are transmitted within the RAR window 930 may include the same scheduling parameters or different scheduling parameters. For example, as shown by example 970, different enhanced RAR PDUs that are transmitted within the RAR window 930 may indicate different scheduling parameters, such as different offsets to a first PDSCH 960 that includes the on-demand SIB1. For example, a first enhanced RAR PDU that is transmitted within the RAR window 930 may indicate a first value for the offset to the first PDSCH 960 that includes the on-demand SIB1, and a second enhanced RAR PDU that is transmitted later in time within the RAR window 930 may indicate a second value for the offset to indicate the same first PDSCH 960 that includes the on-demand SIB1. In this way, regardless of which enhanced RAR PDU the UE 120 successfully decodes within the RAR window 930, the UE 120 receives the same scheduling information for the PDSCH 960 that includes the on-demand SIB1.

Alternatively, as shown by example 980, different enhanced RAR PDUs that are transmitted within the RAR window 930 may indicate the same scheduling parameters, such as the same value for an offset to a first PDSCH 960 that includes the on-demand SIB1. For example, a first enhanced RAR PDU that is transmitted within the RAR window 930 may indicate a given value for the offset to a first set of PDSCHs 960 that includes the on-demand SIB1, and a second enhanced RAR PDU that is transmitted later in time within the RAR window 930 may indicate the same offset value to a second set of PDSCHs 960 that includes the on-demand SIB1. Accordingly, the UE 120 attempts to receive the first set of PDSCHs 960 that includes the on-demand SIB1 if the UE 120 decodes the first enhanced RAR PDU, and attempts to receive the second set of PDSCHs 960 that includes the on-demand SIB1 if the UE 120 decodes the second enhanced RAR PDU. In general, the acquisition latency for the on-demand SIB1 may be shorter in example 980 relative to example 970 (e.g., because the UE 120 has more time to prepare and reliably receive the PDSCHs 960 that include the on-demand SIB1), and energy savings for the NES cell 110 may be greater in example 970 relative to example 980 (e.g., because the NES cell 110 transmits fewer sets of PDSCHs 960 that include the on-demand SIB1).

In some aspects, as described herein, the UE 120 may monitor for the PDSCH 960 that includes the on-demand SIB1 during a time window 950 configured for on-demand SIB1 transmission upon successful reception of the RAR 940. For example, the NES cell 110 may periodically transmit the on-demand SIB1 during the configured time window 950, which may have a starting offset and a duration indicated in the enhanced RAR PDU. For example, the enhanced RAR PDU may indicate the starting offset relative to a reference occasion related to the RAR window 930 in which the RAR 940 was received by the UE 120, relative to a specific PDCCH monitoring occasion within the RAR window 930, or relative to a PRACH occasion associated with the RAR window 930. In some aspects, a transmission periodicity of the on-demand SIB1 within the time window 950 may be indicated in the enhanced RAR PDU, in the UL-WUS configuration 910, or fixed or otherwise defined in a wireless communication standard.

As indicated above, FIG. 9 is provided as an example. Other examples may differ from what is described with regard to FIG. 9.

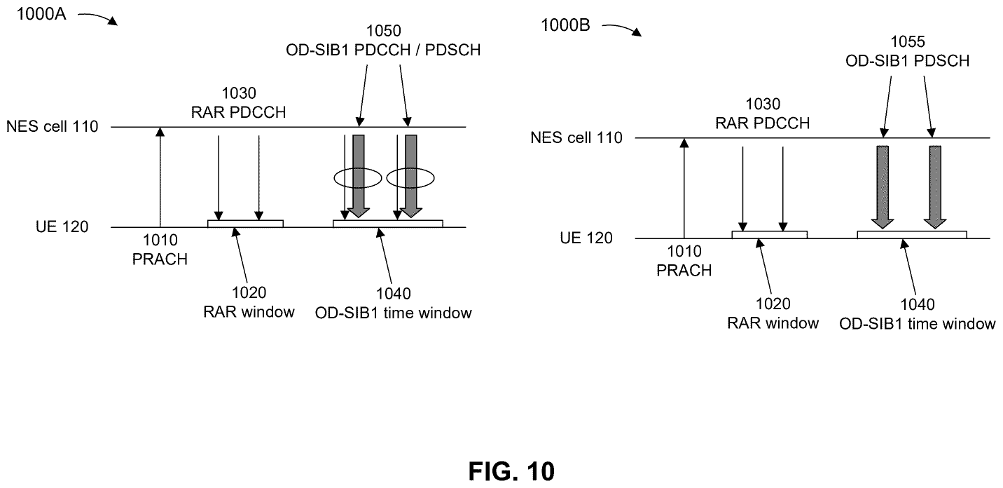

FIG. 10 is a diagram illustrating examples 1000A and 1000B associated with an enhanced RAR for an on-demand SIB, in accordance with the present disclosure. As shown in FIG. 10, examples 1000A and 1000B include communication between a UE 120 and a network node 110. For example, as described herein, the network node 110 provides a cell in which a SIB1 that includes RMSI is transmitted on-demand for network energy savings, and may be referred to herein as an NES cell 110. As described herein, examples 1000A and 1000B illustrate techniques for the UE 120 to request and acquire the on-demand SIB1 according to a msg1-based request. Alternatively, although not shown in FIG. 10, the NES cell 110 may be configured to provision the on-demand SIB1 according to a msg3-based request. In examples 1000A and 1000B, the UE 120 may generally follow steps associated with a typical contention-free random access procedure to transmit and/or retransmit a PRACH and monitor an RAR window to receive an RAR (e.g., as described with reference to FIGS. 4-5).

For example, as described herein, the UE 120 may generally receive an UL-WUS configuration for the NES cell 110, where the UL-WUS configuration may be received from the NES cell 110 or an active cell (e.g., as described above with reference to FIGS. 6A-6C). In some aspects, the UL-WUS configuration may include dedicated PRACH resources (e.g., a dedicated preamble and occasion mask for a PRACH occasion) for requesting the on-demand SIB1. In some aspects, as described herein, the UL-WUS configuration may include partial scheduling information, full scheduling information, or no scheduling information for the on-demand SIB1.

As shown in FIG. 10, in examples 1000A and 1000B, the UE 120 may transmit a PRACH 1010 to the NES cell 110 to request the on-demand SIB1. For example, the PRACH 1010 may be transmitted using the PRACH resources (e.g., the preamble and occasion mask) that are indicated in the UL-WUS configuration for requesting the on-demand SIB1 (e.g., distinct from a preamble and/or PRACH occasion that may be used to request on-demand OSI and/or initial access to the NES cell 110). The UE 120 may then monitor for an RAR PDCCH 1030 from the NES cell 110 during an RAR window 1020. Within the RAR window 1020, the UE may monitor a PDCCH according to a periodicity that is indicated in the UL-WUS configuration. Furthermore, as described herein, the UE 120 may retransmit the PRACH 1010 one or more times (e.g., according to a power ramping rule that may be defined in a wireless communication standard or configured by a network node) if one or more conditions are satisfied.

More particularly, as described herein, the PRACH 1010 transmitted by the UE 120 may include a dedicated preamble for requesting the on-demand SIB1. In some aspects, upon receiving the PRACH 1010 with the dedicated preamble for requesting the on-demand SIB1, the NES cell 110 may transmit, during an RAR window 1020, an enhanced RAR PDCCH 1030 that indicates the dedicated preamble for requesting the on-demand SIB1 to acknowledge that the PRACH 1010 was received at the NES cell 110. Accordingly, after the UE 120 transmits the PRACH 1010 with the dedicated preamble for requesting the on-demand SIB1, the UE 120 may monitor a PDCCH for an RAR within the RAR window 1020. The UE 120 may retransmit the PRACH 1010 according to a power ramping rule if the UE 120 does not detect any PDCCH scrambled by an RA-RNTU, does not receive an RAR with a RAPID set to the dedicated preamble for requesting the on-demand SIB1, and/or does not receive an enhanced PDCCH for the RAR with a RAPID set to the dedicated preamble for requesting the on-demand SIB1 within the RAR window 1020.

In some aspects, as shown in FIG. 10, upon detecting the PRACH 1010 transmitted by the UE 120 to request the on-demand SIB1, the NES cell 110 may transmit an enhanced PDCCH 1030 for the RAR within the RAR window 1020, where the enhanced PDCCH 1030 for the RAR may be scrambled by an RA-RNTI. In example 1000A, the enhanced PDCCH indicates the dedicated preamble for requesting the on-demand SIB1 to acknowledge that the PRACH 1010 was received at the NES cell 110, and the NES cell 110 may drop (e.g., not transmit) any RAR PDSCH within the RAR window 1020. In example 1000A, the NES cell 110 then transmits a PDCCH and a PDSCH 1050 for the on-demand SIB1 within a time window 1040 for on-demand SIB1 transmissions (e.g., in a similar manner as described above with reference to FIG. 8). Alternatively, in example 1000B, the enhanced PDCCH 1030 for the RAR indicates the dedicated preamble for requesting the on-demand SIB1 to acknowledge that the PRACH 1010 was received at the NES cell 110, and further indicates full or partial scheduling information for the on-demand SIB1. Accordingly, in example 1000B, the NES cell 110 may drop (e.g., not transmit) a PDCCH for the on-demand SIB1, and may transmit only a PDSCH 1055 that includes the on-demand SIB1. In cases where the enhanced PDCCH 1030 indicates a partial set of scheduling parameters for the on-demand SIB1, any remaining scheduling parameters for the on-demand SIB1 may be fixed or otherwise defined in a wireless communication standard and/or indicated in the UL-WUS configuration.

In some aspects, although described in connection with FIG. 10, the enhanced PDCCH 1030 may be used in combination with one or more techniques described in more detail elsewhere herein. In particular, in some aspects, the enhanced PDCCH 1030 may be transmitted in response to a PRACH requesting an on-demand SIB1 in examples 800 and 900. For example, the enhanced PDCCH 1030 for the RAR may include a scheme-in-use field to indicate a transmission scheme for the on-demand SIB1, where the scheme-in-use field may indicate that the on-demand SIB1 is transmitted according to the techniques shown in example 800 (e.g., using a PDCCH/PDSCH 840 for the RAR and a PDCCH/PDSCH 860 for the on-demand SIB1), according to the techniques shown in example 900 (e.g., using a PDCCH/PDSCH 940 with an enhanced RAR PDU and only a PDSCH 960 for the on-demand SIB1), according to the techniques shown in example 1000A (e.g., using only the PDCCH 1030 for the RAR and a PDCCH/PDSCH 1050 for the on-demand SIB1), or according to the techniques shown in example 1000B (e.g., using only the PDCCH 1030 for the RAR and only the PDSCH 1055 for the on-demand SIB1).

For example, in one scenario, the NES cell 110 may detect multiple PRACH preambles that are transmitted using the same PRACH resources, including one PRACH that includes the dedicated preamble reserved for requesting the on-demand SIB1 and one or more PRACHs that include other detected preambles (e.g., for requesting initial access). In this scenario, the NES cell 110 may set one or more bits in the enhanced PDCCH 1030 to indicate that the transmission scheme for the on-demand SIB1 corresponds to the techniques shown in example 800 or example 900, and the NES cell 110 may then transmit an RAR PDU on a scheduled PDSCH within the RAR window. In this case, the RAR PDU may include a first RAR subPDU indicating the dedicated preamble for requesting the on-demand SIB1, and a second RAR subPDU for the UEs that are requesting initial access. Alternatively, in a scenario where the NES cell 110 detects only a single PRACH with the dedicated preamble for requesting the on-demand SIB1, the NES cell 110 may set the one or more bits to indicate that the transmission scheme for the on-demand SIB1 corresponds to the techniques shown in example 1000A or example 1000B. In this case, the NES cell 110 may drop the PDSCH for the RAR, and may transmit the on-demand SIB1 on the scheduled PDSCH (e.g., scheduled by the enhanced PDCCH 1030 or a PDCCH for the on-demand SIB1 if the enhanced PDCCH 1030 does not indicate scheduling information for the on-demand SIB1).

Accordingly, as described herein, the enhanced PDCCH 1030 in examples 1000A and 1000B may be associated with a DCI format specific to on-demand SIB1 transmission, or associated with a DCI format for scheduling an RAR or system information. For example, in some aspects, the enhanced PDCCH 1030 may be associated with DCI format 1_0 with a CRC scrambled by an RA-RNTI, and may use one or more reserved bits and/or remap one or more fields in DCI format 1_0 with a CRC scrambled by an RA-RNTI. For example, in some aspects, the DCI format associated with the enhanced PDCCH 1030 may include a field to indicate the transmission scheme for the on-demand SIB1 (e.g., using 2 bits where there are four supported schemes, such as examples 800, 900, 1000A, and 1000B) and a field to indicate the dedicated preamble that triggers the on-demand SIB1 transmission (e.g., using six bits). Additionally, in some aspects, the DCI format associated with the enhanced PDCCH 1030 may further include one or more fields for indicating the scheduling information for the on-demand SIB1 (e.g., when the transmission scheme for the on-demand SIB1 corresponds to example 1000B). For example, fields in DCI format 1_0 for indicating an FDRA, a TDRA, a VRB-to-PRB mapping, and/or an MCS can be reinterpreted for the on-demand SIB1. Additionally, or alternatively, reserved fields of DCI format 1_0 may be used for other scheduling parameters for the on-demand SIB1, such as an RV, a number of consecutive (bundled) PDSCHs for the on-demand SIB1, a starting slot offset of a first PDSCH within the bundle, and a starting offset and duration of the time window 1040 for the on-demand SIB1 transmissions.

As indicated above, FIG. 10 is provided as one or more examples. Other examples may differ from what is described with regard to FIG. 10.

FIG. 11 is a diagram illustrating an example process 1100 performed, for example, at a UE or an apparatus of a UE, in accordance with the present disclosure. Example process 1100 is an example where the apparatus or the UE (e.g., UE 120) performs operations associated with an enhanced RAR for an on-demand SIB.

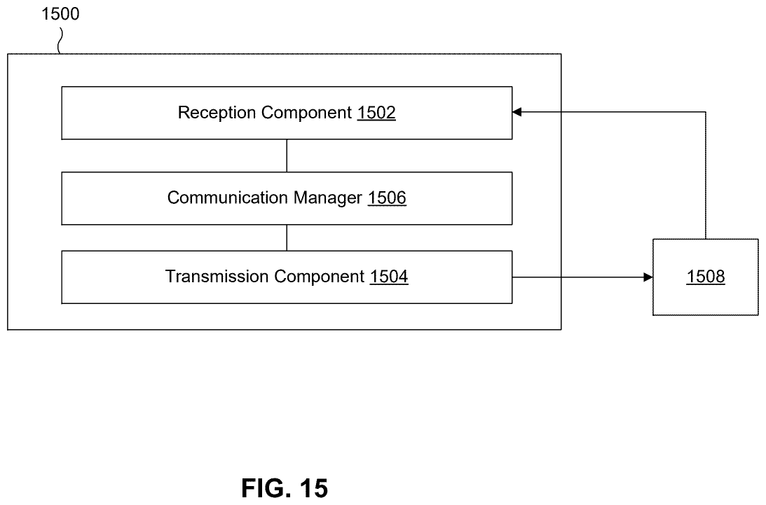

As shown in FIG. 11, in some aspects, process 1100 may include transmitting, to a network node, a PRACH to request an on-demand SIB that includes RMSI (block 1110). For example, the UE (e.g., using transmission component 1504 and/or communication manager 1506, depicted in FIG. 15) may transmit, to a network node, a PRACH to request an on-demand SIB that includes RMSI, as described above.

As further shown in FIG. 11, in some aspects, process 1100 may include receiving, from the network node in response to the PRACH, an RAR PDU, wherein the RAR PDU includes information for the on-demand SIB (block 1120). For example, the UE (e.g., using reception component 1502 and/or communication manager 1506, depicted in FIG. 15) may receive, from the network node in response to the PRACH, an RAR PDU, wherein the RAR PDU includes information for the on-demand SIB, as described above.

As further shown in FIG. 11, in some aspects, process 1100 may include receiving, from the network node, the on-demand SIB based at least in part on the information included in the RAR PDU (block 1130). For example, the UE (e.g., using reception component 1502 and/or communication manager 1506, depicted in FIG. 15) may receive, from the network node, the on-demand SIB based at least in part on the information included in the RAR PDU, as described above.

Process 1100 may include additional aspects, such as any single aspect or any combination of aspects described below and/or in connection with one or more other processes described elsewhere herein.

In a first aspect, the information for the on-demand SIB includes one or more scheduling parameters associated with a PDSCH that includes the on-demand SIB.

In a second aspect, alone or in combination with the first aspect, the RAR PDU includes the information for the on-demand SIB in a MAC RAR SDU of a MAC subPDU associated with the on-demand SIB.

In a third aspect, alone or in combination with one or more of the first and second aspects, the information for the on-demand SIB includes a full set of parameters for scheduling the on-demand SIB.

In a fourth aspect, alone or in combination with one or more of the first through third aspects, the information for the on-demand SIB includes a partial set of parameters for scheduling the on-demand SIB, and a remaining set of parameters for scheduling the on-demand SIB is fixed or indicated in an UL-WUS configuration.

In a fifth aspect, alone or in combination with one or more of the first through fourth aspects, the information for the on-demand SIB indicates a number of consecutive PDSCH transmissions that include the on-demand SIB.

In a sixth aspect, alone or in combination with one or more of the first through fifth aspects, the information for the on-demand SIB indicates a starting slot offset and an RV for a first PDSCH transmission among multiple consecutive PDSCH transmissions that include the on-demand SIB.

In a seventh aspect, alone or in combination with one or more of the first through sixth aspects, the information for the on-demand SIB indicates a starting offset and a duration of a time window in which the on-demand SIB is periodically transmitted.

In an eighth aspect, alone or in combination with one or more of the first through seventh aspects, the information for the on-demand SIB indicates a periodicity of the on-demand SIB within a time window in which the on-demand SIB is periodically transmitted.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram illustrating an example process 1200 performed, for example, at a UE or an apparatus of a UE, in accordance with the present disclosure. Example process 1200 is an example where the apparatus or the UE (e.g., UE 120) performs operations associated with an enhanced RAR for an on-demand SIB.

As shown in FIG. 12, in some aspects, process 1200 may include transmitting, to a network node, a PRACH to request an on-demand SIB that includes RMSI (block 1210). For example, the UE (e.g., using transmission component 1504 and/or communication manager 1506, depicted in FIG. 15) may transmit, to a network node, a PRACH to request an on-demand SIB that includes RMSI, as described above.

As further shown in FIG. 12, in some aspects, process 1200 may include receiving, from the network node in response to the PRACH, only a PDCCH for an RAR during an RAR window (block 1220). For example, the UE (e.g., using reception component 1502 and/or communication manager 1506, depicted in FIG. 15) may receive, from the network node in response to the PRACH, only a PDCCH for an RAR during an RAR window, as described above.

As further shown in FIG. 12, in some aspects, process 1200 may include receiving, from the network node, the on-demand SIB based at least in part on receiving the PDCCH for the RAR (block 1230). For example, the UE (e.g., using reception component 1502 and/or communication manager 1506, depicted in FIG. 15) may receive, from the network node, the on-demand SIB based at least in part on receiving the PDCCH for the RAR, as described above.

Process 1200 may include additional aspects, such as any single aspect or any combination of aspects described below and/or in connection with one or more other processes described elsewhere herein.

In a first aspect, the PRACH includes a dedicated preamble index for the on-demand SIB, and the PDCCH for the RAR indicates the dedicated preamble index for the on-demand SIB to acknowledge reception of the PRACH.

In a second aspect, alone or in combination with the first aspect, the PDCCH for the RAR indicates scheduling information for the on-demand SIB, and receiving the on-demand SIB includes receiving a PDSCH that includes the on-demand SIB based at least in part on the scheduling information indicated in the PDCCH for the RAR.

In a third aspect, alone or in combination with one or more of the first and second aspects, the scheduling information indicated in the PDCCH for the RAR includes a full set of parameters for scheduling the on-demand SIB.

In a fourth aspect, alone or in combination with one or more of the first through third aspects, the scheduling information indicated in the PDCCH for the RAR includes a partial set of parameters for scheduling the on-demand SIB, and a remaining set of parameters for scheduling the on-demand SIB is fixed or indicated in an UL-WUS configuration.

In a fifth aspect, alone or in combination with one or more of the first through fourth aspects, the PDCCH for the RAR indicates a transmission scheme for the on-demand SIB.

In a sixth aspect, alone or in combination with one or more of the first through fifth aspects, the scheduling information included in the PDCCH for the RAR indicates a number of consecutive PDSCH transmissions that include the on-demand SIB.

In a seventh aspect, alone or in combination with one or more of the first through sixth aspects, the scheduling information included in the PDCCH for the RAR indicates a starting slot offset and an RV for a first PDSCH transmission among multiple consecutive PDSCH transmissions that include the on-demand SIB.

In an eighth aspect, alone or in combination with one or more of the first through seventh aspects, the scheduling information included in the PDCCH for the RAR indicates a starting offset and a duration of a time window in which the on-demand SIB is periodically transmitted.

In a ninth aspect, alone or in combination with one or more of the first through eighth aspects, the scheduling information included in the PDCCH for the RAR indicates a periodicity of the on-demand SIB within a time window in which the on-demand SIB is periodically transmitted.

In a tenth aspect, alone or in combination with one or more of the first through ninth aspects, process 1200 includes retransmitting the PRACH to request the on-demand SIB according to a power ramping rule based at least in part on not detecting a PDCCH scrambled by an RA-RNTI during the RAR window.

In an eleventh aspect, alone or in combination with one or more of the first through tenth aspects, process 1200 includes retransmitting the PRACH to request the on-demand SIB according to a power ramping rule based at least in part on not receiving a message that indicates a dedicated preamble index for the on-demand SIB during the RAR window.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram illustrating an example process 1300 performed, for example, at a network node or an apparatus of a network node, in accordance with the present disclosure. Example process 1300 is an example where the apparatus or the network node (e.g., network node 110) performs operations associated with an enhanced RAR for an on-demand SIB.

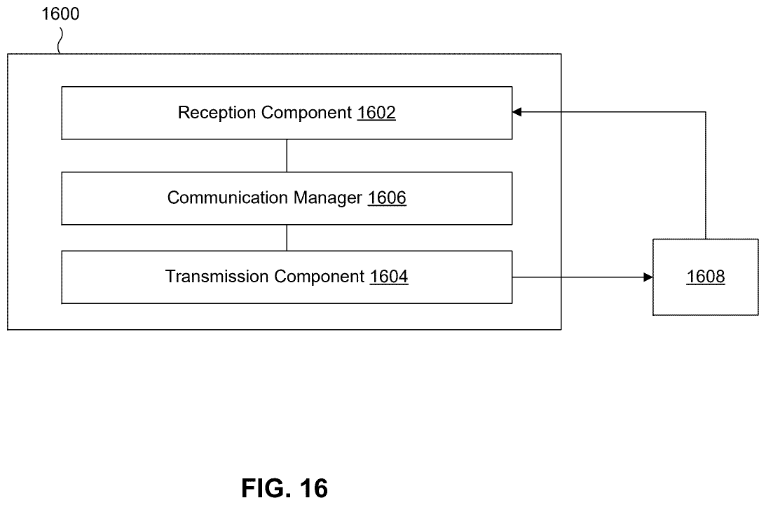

As shown in FIG. 13, in some aspects, process 1300 may include receiving, from a UE, a PRACH requesting an on-demand SIB that includes RMSI (block 1310). For example, the network node (e.g., using reception component 1602 and/or communication manager 1606, depicted in FIG. 16) may receive, from a UE, a PRACH requesting an on-demand SIB that includes RMSI, as described above.

As further shown in FIG. 13, in some aspects, process 1300 may include transmitting, to the UE in response to the PRACH, one or more RAR PDUs during an RAR window, wherein the one or more RAR PDUs each include information for the on-demand SIB (block 1320). For example, the network node (e.g., using transmission component 1604 and/or communication manager 1606, depicted in FIG. 16) may transmit, to the UE in response to the PRACH, one or more RAR PDUs during an RAR window, wherein the one or more RAR PDUs each include information for the on-demand SIB, as described above.

As further shown in FIG. 13, in some aspects, process 1300 may include transmitting the on-demand SIB based at least in part on the information included in the one or more RAR PDUs (block 1330). For example, the network node (e.g., using transmission component 1604 and/or communication manager 1606, depicted in FIG. 16) may transmit the on-demand SIB based at least in part on the information included in the one or more RAR PDUs, as described above.

Process 1300 may include additional aspects, such as any single aspect or any combination of aspects described below and/or in connection with one or more other processes described elsewhere herein.

In a first aspect, the information for the on-demand SIB includes one or more scheduling parameters for a PDSCH that includes the on-demand SIB.

In a second aspect, alone or in combination with the first aspect, the RAR PDU includes the information for the on-demand SIB in a MAC RAR SDU of a MAC subPDU associated with the on-demand SIB.

In a third aspect, alone or in combination with one or more of the first and second aspects, the information for the on-demand SIB includes a full set of parameters for scheduling the on-demand SIB.

In a fourth aspect, alone or in combination with one or more of the first through third aspects, the information for the on-demand SIB includes a partial set of parameters for scheduling the on-demand SIB, and a remaining set of parameters for scheduling the on-demand SIB is fixed or indicated in an UL-WUS configuration.

In a fifth aspect, alone or in combination with one or more of the first through fourth aspects, the information for the on-demand SIB indicates a number of consecutive PDSCH transmissions that include the on-demand SIB.

In a sixth aspect, alone or in combination with one or more of the first through fifth aspects, the information for the on-demand SIB indicates a starting slot offset and an RV for a first PDSCH transmission among multiple consecutive PDSCH transmissions that include the on-demand SIB.

In a seventh aspect, alone or in combination with one or more of the first through sixth aspects, the information for the on-demand SIB indicates a starting offset and a duration of a time window in which the on-demand SIB is periodically transmitted.

In an eighth aspect, alone or in combination with one or more of the first through seventh aspects, the information for the on-demand SIB indicates a periodicity of the on-demand SIB within a time window in which the on-demand SIB is periodically transmitted.

In a ninth aspect, alone or in combination with one or more of the first through eighth aspects, the one or more RAR PDUs include a first RAR PDU and a second RAR PDU that have different values for one or more parameters included in the information for the on-demand SIB.

In a tenth aspect, alone or in combination with one or more of the first through ninth aspects, the one or more RAR PDUs include a first RAR PDU and a second RAR PDU that have identical values for each parameter included in the information for the on-demand SIB.

Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

FIG. 14 is a diagram illustrating an example process 1400 performed, for example, at a network node or an apparatus of a network node, in accordance with the present disclosure. Example process 1400 is an example where the apparatus or the network node (e.g., network node 110) performs operations associated with an enhanced RAR for an on-demand SIB.

As shown in FIG. 14, in some aspects, process 1400 may include receiving, from a UE, a PRACH to request an on-demand SIB that includes RMSI (block 1410). For example, the network node (e.g., using reception component 1602 and/or communication manager 1606, depicted in FIG. 16) may receive, from a UE, a PRACH to request an on-demand SIB that includes RMSI, as described above.

As further shown in FIG. 14, in some aspects, process 1400 may include transmitting, to the UE in response to the PRACH, only a PDCCH for an RAR during an RAR window (block 1420). For example, the network node (e.g., using transmission component 1604 and/or communication manager 1606, depicted in FIG. 16) may transmit, to the UE in response to the PRACH, only a PDCCH for an RAR during an RAR window, as described above.

As further shown in FIG. 14, in some aspects, process 1400 may include transmitting the on-demand SIB based at least in part on the PDCCH for the RAR (block 1430). For example, the network node (e.g., using transmission component 1604 and/or communication manager 1606, depicted in FIG. 16) may transmit the on-demand SIB based at least in part on the PDCCH for the RAR, as described above.

Process 1400 may include additional aspects, such as any single aspect or any combination of aspects described below and/or in connection with one or more other processes described elsewhere herein.

In a first aspect, the PRACH includes a dedicated preamble index for the on-demand SIB, and the PDCCH for the RAR indicates the dedicated preamble index for the on-demand SIB to acknowledge reception of the PRACH.

In a second aspect, alone or in combination with the first aspect, the PDCCH for the RAR indicates scheduling information for the on-demand SIB, and transmitting the on-demand SIB includes transmitting a PDSCH that includes the on-demand SIB based at least in part on the scheduling information indicated in the PDCCH for the RAR.

In a third aspect, alone or in combination with one or more of the first and second aspects, the scheduling information indicated in the PDCCH for the RAR includes a full set of parameters for scheduling the on-demand SIB.

In a fourth aspect, alone or in combination with one or more of the first through third aspects, the scheduling information indicated in the PDCCH for the RAR includes a partial set of parameters for scheduling the on-demand SIB, and a remaining set of parameters for scheduling the on-demand SIB is fixed or indicated in an UL-WUS configuration.

In a fifth aspect, alone or in combination with one or more of the first through fourth aspects, the PDCCH for the RAR indicates a transmission scheme for the on-demand SIB.

In a sixth aspect, alone or in combination with one or more of the first through fifth aspects, the scheduling information included in the PDCCH for the RAR indicates a number of consecutive PDSCH transmissions that include the on-demand SIB.

In a seventh aspect, alone or in combination with one or more of the first through sixth aspects, the scheduling information included in the PDCCH for the RAR indicates a starting slot offset and an RV for a first PDSCH transmission among multiple consecutive PDSCH transmissions that include the on-demand SIB.

In an eighth aspect, alone or in combination with one or more of the first through seventh aspects, the scheduling information included in the PDCCH for the RAR indicates a starting offset and a duration of a time window in which the on-demand SIB is periodically transmitted.

In a ninth aspect, alone or in combination with one or more of the first through eighth aspects, the scheduling information included in the PDCCH for the RAR indicates a periodicity of the on-demand SIB within a time window in which the on-demand SIB is periodically transmitted.

Although FIG. 14 shows example blocks of process 1400, in some aspects, process 1400 may include additional blocks, fewer blocks, different blocks, or differently arranged blocks than those depicted in FIG. 14. Additionally, or alternatively, two or more of the blocks of process 1400 may be performed in parallel.

FIG. 15 is a diagram of an example apparatus 1500 for wireless communication, in accordance with the present disclosure. The apparatus 1500 may be a UE, or a UE may include the apparatus 1500. In some aspects, the apparatus 1500 includes a reception component 1502, a transmission component 1504, and/or a communication manager 1506, which may be in communication with one another (for example, via one or more buses and/or one or more other components). In some aspects, the communication manager 1506 is the communication manager 150 described in connection with FIG. 1. As shown, the apparatus 1500 may communicate with another apparatus 1508, such as a UE or a network node (such as a CU, a DU, an RU, or a base station), using the reception component 1502 and the transmission component 1504.

In some aspects, the apparatus 1500 may be configured to perform one or more operations described herein in connection with FIGS. 8-10. Additionally, or alternatively, the apparatus 1500 may be configured to perform one or more processes described herein, such as process 1100 of FIG. 11, process 1200 of FIG. 12, or a combination thereof. In some aspects, the apparatus 1500 and/or one or more components shown in FIG. 15 may include one or more components of the UE described in connection with FIG. 1 and FIG. 2. Additionally, or alternatively, one or more components shown in FIG. 15 may be implemented within one or more components described in connection with FIG. 1 and FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1502 may receive communications, such as reference signals, control information, data communications, or a combination thereof, from the apparatus 1508. The reception component 1502 may provide received communications to one or more other components of the apparatus 1500. In some aspects, the reception component 1502 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1500. In some aspects, the reception component 1502 may include one or more antennas, one or more modems, one or more demodulators, one or more MIMO detectors, one or more receive processors, one or more controllers/processors, one or more memories, or a combination thereof, of the UE described in connection with FIG. 1 and FIG. 2.

The transmission component 1504 may transmit communications, such as reference signals, control information, data communications, or a combination thereof, to the apparatus 1508. In some aspects, one or more other components of the apparatus 1500 may generate communications and may provide the generated communications to the transmission component 1504 for transmission to the apparatus 1508. In some aspects, the transmission component 1504 may perform signal processing on the generated communications (such as filtering, amplification, modulation, digital-to-analog conversion, multiplexing, interleaving, mapping, or encoding, among other examples), and may transmit the processed signals to the apparatus 1508. In some aspects, the transmission component 1504 may include one or more antennas, one or more modems, one or more modulators, one or more transmit MIMO processors, one or more transmit processors, one or more controllers/processors, one or more memories, or a combination thereof, of the UE described in connection with FIG. 1 and FIG. 2. In some aspects, the transmission component 1504 may be co-located with the reception component 1502 in one or more transceivers.

The communication manager 1506 may support operations of the reception component 1502 and/or the transmission component 1504. For example, the communication manager 1506 may receive information associated with configuring reception of communications by the reception component 1502 and/or transmission of communications by the transmission component 1504. Additionally, or alternatively, the communication manager 1506 may generate and/or provide control information to the reception component 1502 and/or the transmission component 1504 to control reception and/or transmission of communications.

The transmission component 1504 may transmit, to a network node, a PRACH to request an on-demand SIB that includes RMSI. The reception component 1502 may receive, from the network node in response to the PRACH, an RAR PDU, wherein the RAR PDU includes information for the on-demand SIB. The reception component 1502 may receive, from the network node, the on-demand SIB based at least in part on the information included in the RAR PDU.

The transmission component 1504 may transmit, to a network node, a PRACH to request an on-demand SIB that includes RMSI. The reception component 1502 may receive, from the network node in response to the PRACH, only a PDCCH for an RAR during an RAR window. The reception component 1502 may receive, from the network node, the on-demand SIB based at least in part on receiving the PDCCH for the RAR.

The number and arrangement of components shown in FIG. 15 are provided as an example. In practice, there may be additional components, fewer components, different components, or differently arranged components than those shown in FIG. 15. Furthermore, two or more components shown in FIG. 15 may be implemented within a single component, or a single component shown in FIG. 15 may be implemented as multiple, distributed components. Additionally, or alternatively, a set of (one or more) components shown in FIG. 15 may perform one or more functions described as being performed by another set of components shown in FIG. 15.

FIG. 16 is a diagram of an example apparatus 1600 for wireless communication, in accordance with the present disclosure. The apparatus 1600 may be a network node, or a network node may include the apparatus 1600. In some aspects, the apparatus 1600 includes a reception component 1602, a transmission component 1604, and/or a communication manager 1606, which may be in communication with one another (for example, via one or more buses and/or one or more other components). In some aspects, the communication manager 1606 is the communication manager 160 described in connection with FIG. 1. As shown, the apparatus 1600 may communicate with another apparatus 1608, such as a UE or a network node (such as a CU, a DU, an RU, or a base station), using the reception component 1602 and the transmission component 1604.

In some aspects, the apparatus 1600 may be configured to perform one or more operations described herein in connection with FIGS. 8-10. Additionally, or alternatively, the apparatus 1600 may be configured to perform one or more processes described herein, such as process 1300 of FIG. 13, process 1400 of FIG. 14, or a combination thereof. In some aspects, the apparatus 1600 and/or one or more components shown in FIG. 16 may include one or more components of the network node described in connection with FIG. 1 and FIG. 2. Additionally, or alternatively, one or more components shown in FIG. 16 may be implemented within one or more components described in connection with FIG. 1 and FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1602 may receive communications, such as reference signals, control information, data communications, or a combination thereof, from the apparatus 1608. The reception component 1602 may provide received communications to one or more other components of the apparatus 1600. In some aspects, the reception component 1602 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1600. In some aspects, the reception component 1602 may include one or more antennas, one or more modems, one or more demodulators, one or more MIMO detectors, one or more receive processors, one or more controllers/processors, one or more memories, or a combination thereof, of the network node described in connection with FIG. 1 and FIG. 2. In some aspects, the reception component 1602 and/or the transmission component 1604 may include or may be included in a network interface. The network interface may be configured to obtain and/or output signals for the apparatus 1600 via one or more communications links, such as a backhaul link, a midhaul link, and/or a fronthaul link.

The transmission component 1604 may transmit communications, such as reference signals, control information, data communications, or a combination thereof, to the apparatus 1608. In some aspects, one or more other components of the apparatus 1600 may generate communications and may provide the generated communications to the transmission component 1604 for transmission to the apparatus 1608. In some aspects, the transmission component 1604 may perform signal processing on the generated communications (such as filtering, amplification, modulation, digital-to-analog conversion, multiplexing, interleaving, mapping, or encoding, among other examples), and may transmit the processed signals to the apparatus 1608. In some aspects, the transmission component 1604 may include one or more antennas, one or more modems, one or more modulators, one or more transmit MIMO processors, one or more transmit processors, one or more controllers/processors, one or more memories, or a combination thereof, of the network node described in connection with FIG. 1 and FIG. 2. In some aspects, the transmission component 1604 may be co-located with the reception component 1602 in one or more transceivers.

The communication manager 1606 may support operations of the reception component 1602 and/or the transmission component 1604. For example, the communication manager 1606 may receive information associated with configuring reception of communications by the reception component 1602 and/or transmission of communications by the transmission component 1604. Additionally, or alternatively, the communication manager 1606 may generate and/or provide control information to the reception component 1602 and/or the transmission component 1604 to control reception and/or transmission of communications.

The reception component 1602 may receive, from a UE, a PRACH requesting an on-demand SIB that includes RMSI. The transmission component 1604 may transmit, to the UE in response to the PRACH, one or more RAR PDUs during an RAR window, wherein the one or more RAR PDUs each include information for the on-demand SIB. The transmission component 1604 may transmit the on-demand SIB based at least in part on the information included in the one or more RAR PDUs.

The reception component 1602 may receive, from a UE, a PRACH to request an on-demand SIB that includes RMSI. The transmission component 1604 may transmit, to the UE in response to the PRACH, only a PDCCH for an RAR during an RAR window. The transmission component 1604 may transmit the on-demand SIB based at least in part on the PDCCH for the RAR.

The number and arrangement of components shown in FIG. 16 are provided as an example. In practice, there may be additional components, fewer components, different components, or differently arranged components than those shown in FIG. 16. Furthermore, two or more components shown in FIG. 16 may be implemented within a single component, or a single component shown in FIG. 16 may be implemented as multiple, distributed components. Additionally, or alternatively, a set of (one or more) components shown in FIG. 16 may perform one or more functions described as being performed by another set of components shown in FIG. 16.

The following provides an overview of some Aspects of the present disclosure:

Aspect 1: A method of wireless communication performed by a UE, comprising: transmitting, to a network node, a PRACH to request an on-demand SIB that includes RMSI; receiving, from the network node in response to the PRACH, an RAR PDU, wherein the RAR PDU includes information for the on-demand SIB; and receiving, from the network node, the on-demand SIB based at least in part on the information included in the RAR PDU.

Aspect 2: The method of Aspect 1, wherein the information for the on-demand SIB includes one or more scheduling parameters for a PDSCH that includes the on-demand SIB.

Aspect 3: The method of any of Aspects 1-2, wherein the RAR PDU includes the information for the on-demand SIB in a MAC RAR SDU of a MAC subPDU associated with the on-demand SIB.

Aspect 4: The method of any of Aspects 1-3, wherein the information for the on-demand SIB includes a full set of parameters for scheduling the on-demand SIB.

Aspect 5: The method of any of Aspects 1-4, wherein the information for the on-demand SIB includes a partial set of parameters for scheduling the on-demand SIB, and wherein a remaining set of parameters for scheduling the on-demand SIB is fixed or indicated in an UL-WUS configuration.

Aspect 6: The method of any of Aspects 1-5, wherein the information for the on-demand SIB indicates a number of consecutive PDSCH transmissions that include the on-demand SIB.

Aspect 7: The method of any of Aspects 1-6, wherein the information for the on-demand SIB indicates a starting slot offset and an RV for a first PDSCH transmission among multiple consecutive PDSCH transmissions that include the on-demand SIB.

Aspect 8: The method of any of Aspects 1-7, wherein the information for the on-demand SIB indicates a starting offset and a duration of a time window in which the on-demand SIB is periodically transmitted.

Aspect 9: The method of any of Aspects 1-8, wherein the information for the on-demand SIB indicates a periodicity of the on-demand SIB within a time window in which the on-demand SIB is periodically transmitted.

Aspect 10: A method of wireless communication performed by a UE, comprising: transmitting, to a network node, a PRACH to request an on-demand SIB that includes RMSI; receiving, from the network node in response to the PRACH, only a PDCCH for an RAR during an RAR window; and receiving, from the network node, the on-demand SIB based at least in part on receiving the PDCCH for the RAR.

Aspect 11: The method of Aspect 10, wherein the PRACH includes a dedicated preamble index for the on-demand SIB, and wherein the PDCCH for the RAR indicates the dedicated preamble index for the on-demand SIB to acknowledge reception of the PRACH.

Aspect 12: The method of any of Aspects 10-11, wherein the PDCCH for the RAR indicates scheduling information for the on-demand SIB, and wherein receiving the on-demand SIB includes receiving a PDSCH that includes the on-demand SIB based at least in part on the scheduling information indicated in the PDCCH for the RAR.

Aspect 13: The method of Aspect 12, wherein the scheduling information indicated in the PDCCH for the RAR includes a full set of parameters for scheduling the on-demand SIB.

Aspect 14: The method of Aspect 12, wherein the scheduling information indicated in the PDCCH for the RAR includes a partial set of parameters for scheduling the on-demand SIB, and wherein a remaining set of parameters for scheduling the on-demand SIB is fixed or indicated in an UL-WUS configuration.

Aspect 15: The method of Aspect 12, wherein the PDCCH for the RAR indicates a transmission scheme for the on-demand SIB.

Aspect 16: The method of Aspect 12, wherein the scheduling information included in the PDCCH for the RAR indicates a number of consecutive PDSCH transmissions that include the on-demand SIB.

Aspect 17: The method of Aspect 12, wherein the scheduling information included in the PDCCH for the RAR indicates a starting slot offset and an RV for a first PDSCH transmission among multiple consecutive PDSCH transmissions that include the on-demand SIB.

Aspect 18: The method of Aspect 12, wherein the scheduling information included in the PDCCH for the RAR indicates a starting offset and a duration of a time window in which the on-demand SIB is periodically transmitted.

Aspect 19: The method of Aspect 12, wherein the scheduling information included in the PDCCH for the RAR indicates a periodicity of the on-demand SIB within a time window in which the on-demand SIB is periodically transmitted.

Aspect 20: The method of any of Aspects 10-19, further comprising: retransmitting the PRACH to request the on-demand SIB according to a power ramping rule based at least in part on not detecting a PDCCH scrambled by an RA-RNTI during the RAR window.

Aspect 21: The method of any of Aspects 10-20, further comprising: retransmitting the PRACH to request the on-demand SIB according to a power ramping rule based at least in part on not receiving a message that indicates a dedicated preamble index for the on-demand SIB during the RAR window.

Aspect 22: A method of wireless communication performed by a network node, comprising: receiving, from a UE, a PRACH requesting an on-demand SIB that includes RMSI; transmitting, to the UE in response to the PRACH, one or more RAR PDUs during an RAR window, wherein the one or more RAR PDUs each include information for the on-demand SIB; and transmitting the on-demand SIB based at least in part on the information included in the one or more RAR PDUs.

Aspect 23: The method of Aspect 22, wherein the information for the on-demand SIB includes one or more scheduling parameters for a PDSCH that includes the on-demand SIB.

Aspect 24: The method of any of Aspects 22-23, wherein the RAR PDU includes the information for the on-demand SIB in a MAC RAR SDU of a MAC subPDU associated with the on-demand SIB.

Aspect 25: The method of any of Aspects 22-24, wherein the information for the on-demand SIB includes a full set of parameters for scheduling the on-demand SIB.

Aspect 26: The method of any of Aspects 22-25, wherein the information for the on-demand SIB includes a partial set of parameters for scheduling the on-demand SIB, and wherein a remaining set of parameters for scheduling the on-demand SIB is fixed or indicated in an UL-WUS configuration.

Aspect 27: The method of any of Aspects 22-26, wherein the information for the on-demand SIB indicates a number of consecutive PDSCH transmissions that include the on-demand SIB.

Aspect 28: The method of any of Aspects 22-27, wherein the information for the on-demand SIB indicates a starting slot offset and an RV for a first PDSCH transmission among multiple consecutive PDSCH transmissions that include the on-demand SIB.

Aspect 29: The method of any of Aspects 22-28, wherein the information for the on-demand SIB indicates a starting offset and a duration of a time window in which the on-demand SIB is periodically transmitted.

Aspect 30: The method of any of Aspects 22-29, wherein the information for the on-demand SIB indicates a periodicity of the on-demand SIB within a time window in which the on-demand SIB is periodically transmitted.

Aspect 31: The method of any of Aspects 22-30, wherein the one or more RAR PDUs include a first RAR PDU and a second RAR PDU that have different values for one or more parameters included in the scheduling information for the on-demand SIB.

Aspect 32: The method of any of Aspects 22-31, wherein the one or more RAR PDUs include a first RAR PDU and a second RAR PDU that have identical values for each parameter included in the scheduling information for the on-demand SIB.

Aspect 33: A method of wireless communication performed by a network node, comprising: receiving, from a UE, a PRACH to request an on-demand SIB that includes RMSI; transmitting, to the UE in response to the PRACH, only a PDCCH for an RAR during an RAR window; and transmitting the on-demand SIB based at least in part on the PDCCH for the RAR.

Aspect 34: The method of Aspect 33, wherein the PRACH includes a dedicated preamble index for the on-demand SIB, and wherein the PDCCH for the RAR indicates the dedicated preamble index for the on-demand SIB to acknowledge reception of the PRACH.

Aspect 35: The method of any of Aspects 33-34, wherein the PDCCH for the RAR indicates scheduling information for the on-demand SIB, and wherein transmitting the on-demand SIB includes transmitting a PDSCH that includes the on-demand SIB based at least in part on the scheduling information indicated in the PDCCH for the RAR.

Aspect 36: The method of Aspect 35, wherein the scheduling information indicated in the PDCCH for the RAR includes a full set of parameters for scheduling the on-demand SIB.

Aspect 37: The method of Aspect 35, wherein the scheduling information indicated in the PDCCH for the RAR includes a partial set of parameters for scheduling the on-demand SIB, and wherein a remaining set of parameters for scheduling the on-demand SIB is fixed or indicated in an UL-WUS configuration.

Aspect 38: The method of Aspect 35, wherein the PDCCH for the RAR indicates a transmission scheme for the on-demand SIB.

Aspect 39: The method of Aspect 35, wherein the scheduling information included in the PDCCH for the RAR indicates a number of consecutive PDSCH transmissions that include the on-demand SIB.

Aspect 40: The method of Aspect 35, wherein the scheduling information included in the PDCCH for the RAR indicates a starting slot offset and an RV for a first PDSCH transmission among multiple consecutive PDSCH transmissions that include the on-demand SIB.

Aspect 41: The method of Aspect 35, wherein the scheduling information included in the PDCCH for the RAR indicates a starting offset and a duration of a time window in which the on-demand SIB is periodically transmitted.

Aspect 42: The method of Aspect 35, wherein the scheduling information included in the PDCCH for the RAR indicates a periodicity of the on-demand SIB within a time window in which the on-demand SIB is periodically transmitted.

Aspect 43: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-42.

Aspect 44: An apparatus for wireless communication at a device, the apparatus comprising one or more memories and one or more processors coupled to the one or more memories, the one or more processors configured to cause the device to perform the method of one or more of Aspects 1-42.

Aspect 45: An apparatus for wireless communication, the apparatus comprising at least one means for performing the method of one or more of Aspects 1-42.

Aspect 46: A non-transitory computer-readable medium storing code for wireless communication, the code comprising instructions executable by one or more processors to perform the method of one or more of Aspects 1-42.

Aspect 47: A non-transitory computer-readable medium storing a set of instructions for wireless communication, the set of instructions comprising one or more instructions that, when executed by one or more processors of a device, cause the device to perform the method of one or more of Aspects 1-42.

Aspect 48: A device for wireless communication, the device comprising a processing system that includes one or more processors and one or more memories coupled with the one or more processors, the processing system configured to cause the device to perform the method of one or more of Aspects 1-42.

Aspect 49: An apparatus for wireless communication at a device, the apparatus comprising one or more memories and one or more processors coupled to the one or more memories, the one or more processors individually or collectively configured to cause the device to perform the method of one or more of Aspects 1-42.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware, firmware, or a combination of hardware and software. As used herein, a processor is implemented in hardware, firmware, or a combination of hardware and software. As used herein, the phrase “based on” is intended to be broadly construed to mean “based at least in part on.” As used herein, “satisfying a threshold” may, depending on the context, refer to a value being greater than the threshold, greater than or equal to the threshold, less than the threshold, less than or equal to the threshold, equal to the threshold, or not equal to the threshold, among other examples. As used herein, a phrase referring to “at least one of” a list of items refers to any combination of those items, including single members. As an example, “at least one of: a, b, or c” is intended to cover: a, b, c, a+b, a+c, b+c, and a+b+c.

Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (for example, related items, unrelated items, or a combination of related and unrelated items), and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A also may have B). Further, as used herein, the term “or” is intended to be inclusive when used in a series and may be used interchangeably with “and/or,” unless explicitly stated otherwise (for example, if used in combination with “either” or “only one of”).

The various illustrative logics, logical blocks, modules, circuits and algorithm processes described in connection with the aspects disclosed herein may be implemented as electronic hardware, computer software, or combinations of both. The interchangeability of hardware and software has been described generally, in terms of functionality, and illustrated in the various illustrative components, blocks, modules, circuits and processes described herein. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some aspects, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Aspects of the subject matter described in this specification also can be implemented as one or more computer programs (such as one or more modules of computer program instructions) encoded on a computer storage media for execution by, or to control the operation of, a data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the media described herein should also be included within the scope of computer-readable media. Additionally, the operations of a method or algorithm may reside as one or any combination or set of codes and instructions on a machine readable medium and computer-readable medium, which may be incorporated into a computer program product.

Various modifications to the aspects described in this disclosure may be readily apparent to those skilled in the art, and the generic principles defined herein may be applied to other aspects without departing from the spirit or scope of this disclosure. Thus, the claims are not intended to be limited to the aspects shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate aspects also can be implemented in combination in a single aspect. Conversely, various features that are described in the context of a single aspect also can be implemented in multiple aspects separately or in any suitable subcombination. Moreover, although features may be described as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the aspects described should not be understood as requiring such separation in all aspects, and it should be understood that the described program components and systems can generally be integrated together in a single software product or packaged into multiple software products. Additionally, other aspects are within the scope of the following claims. In some cases, the actions recited in the claims can be performed in a different order and still achieve desirable results.

What is claimed is:

1. A method of wireless communication performed by a user equipment (UE), comprising:
transmitting, to a network node, a physical random access channel (PRACH) to request an on-demand system information block (SIB) that includes remaining minimum system information (RMSI);
receiving, from the network node in response to the PRACH, a random access response (RAR) protocol data unit (PDU), wherein the RAR PDU includes information for the on-demand SIB; and
receiving, from the network node, the on-demand SIB based at least in part on the information included in the RAR PDU.

2. The method of claim 1, wherein the information for the on-demand SIB includes one or more scheduling parameters associated with a physical downlink shared channel (PDSCH) that includes the on-demand SIB.

3. The method of claim 1, wherein the RAR PDU includes the information for the on-demand SIB in a medium access control (MAC) RAR service data unit (SDU) of a MAC subPDU associated with the on-demand SIB.

4. The method of claim 1, wherein the information for the on-demand SIB includes a full set of parameters for scheduling the on-demand SIB.

5. The method of claim 1, wherein the information for the on-demand SIB includes a partial set of parameters for scheduling the on-demand SIB, and wherein a remaining set of parameters for scheduling the on-demand SIB is fixed or indicated in an uplink wakeup signal (UL-WUS) configuration.

6. The method of claim 1, wherein the information for the on-demand SIB indicates a number of consecutive physical downlink shared channel (PDSCH) transmissions that include the on-demand SIB.

7. The method of claim 1, wherein the information for the on-demand SIB indicates a starting slot offset and a redundancy version (RV) for a first physical downlink shared channel (PDSCH) transmission among multiple consecutive PDSCH transmissions that include the on-demand SIB.

8. The method of claim 1, wherein the information for the on-demand SIB indicates a starting offset and a duration of a time window in which the on-demand SIB is periodically transmitted.

9. The method of claim 1, wherein the information for the on-demand SIB indicates a periodicity of the on-demand SIB within a time window in which the on-demand SIB is periodically transmitted.

10. A method of wireless communication performed by a user equipment (UE), comprising:
transmitting, to a network node, a physical random access channel (PRACH) to request an on-demand system information block (SIB) that includes remaining minimum system information (RMSI);
receiving, from the network node in response to the PRACH, only a physical downlink control channel (PDCCH) for a random access response (RAR) during an RAR window; and
receiving, from the network node, the on-demand SIB based at least in part on receiving the PDCCH for the RAR.

11. The method of claim 10, wherein the PRACH includes a dedicated preamble index for the on-demand SIB, and wherein the PDCCH for the RAR indicates the dedicated preamble index for the on-demand SIB to acknowledge reception of the PRACH.

12. The method of claim 10, wherein the PDCCH for the RAR indicates scheduling information for the on-demand SIB, and wherein receiving the on-demand SIB includes receiving a physical downlink shared channel (PDSCH) that includes the on-demand SIB based at least in part on the scheduling information indicated in the PDCCH for the RAR.

13. The method of claim 12, wherein the scheduling information indicated in the PDCCH for the RAR includes a full set of parameters for scheduling the on-demand SIB.

14. The method of claim 12, wherein the scheduling information indicated in the PDCCH for the RAR includes a partial set of parameters for scheduling the on-demand SIB, and wherein a remaining set of parameters for scheduling the on-demand SIB is fixed or indicated in an uplink wakeup signal (UL-WUS) configuration.

15. The method of claim 12, wherein the PDCCH for the RAR indicates a transmission scheme for the on-demand SIB.

16. The method of claim 12, wherein the scheduling information included in the PDCCH for the RAR indicates a number of consecutive physical downlink shared channel (PDSCH) transmissions that include the on-demand SIB.

17. The method of claim 12, wherein the scheduling information included in the PDCCH for the RAR indicates a starting slot offset and a redundancy version (RV) for a first physical downlink shared channel (PDSCH) transmission among multiple consecutive PDSCH transmissions that include the on-demand SIB.

18. The method of claim 12, wherein the scheduling information included in the PDCCH for the RAR indicates a starting offset and a duration of a time window in which the on-demand SIB is periodically transmitted.

19. The method of claim 12, wherein the scheduling information included in the PDCCH for the RAR indicates a periodicity of the on-demand SIB within a time window in which the on-demand SIB is periodically transmitted.

20. The method of claim 10, further comprising:
retransmitting the PRACH to request the on-demand SIB according to a power ramping rule based at least in part on not detecting a PDCCH scrambled by a random access radio network temporary identifier (RA-RNTI) during the RAR window.

21. The method of claim 10, further comprising:
retransmitting the PRACH to request the on-demand SIB according to a power ramping rule based at least in part on not receiving a message that indicates a dedicated preamble index for the on-demand SIB during the RAR window.

22. A method of wireless communication performed by a network node, comprising:
receiving, from a user equipment (UE), a physical random access channel (PRACH) requesting an on-demand system information block (SIB) that includes remaining minimum system information (RMSI);
transmitting, to the UE in response to the PRACH, one or more random access response (RAR) protocol data units (PDUs) during an RAR window, wherein the one or more RAR PDUs each include information for the on-demand SIB; and
transmitting the on-demand SIB based at least in part on the information included in the one or more RAR PDUs.

23. The method of claim 22, wherein the information for the on-demand SIB includes a full set of parameters for scheduling the on-demand SIB.

24. The method of claim 22, wherein the information for the on-demand SIB includes a partial set of parameters for scheduling the on-demand SIB, and wherein a remaining set of parameters for scheduling the on-demand SIB is fixed or indicated in an uplink wakeup signal (UL-WUS) configuration.

25. The method of claim 22, wherein the one or more RAR PDUs include a first RAR PDU and a second RAR PDU that have different values for one or more parameters included in the information for the on-demand SIB.

26. The method of claim 22, wherein the one or more RAR PDUs include a first RAR PDU and a second RAR PDU that have identical values for each parameter included in the information for the on-demand SIB.

27. A method of wireless communication performed by a network node, comprising:
receiving, from a user equipment (UE), a physical random access channel (PRACH) to request an on-demand system information block (SIB) that includes remaining minimum system information (RMSI);
transmitting, to the UE in response to the PRACH, only a physical downlink control channel (PDCCH) for a random access response (RAR) during an RAR window; and
transmitting the on-demand SIB based at least in part on the PDCCH for the RAR.

28. The method of claim 27, wherein the PRACH includes a dedicated preamble index for the on-demand SIB, and wherein the PDCCH for the RAR indicates the dedicated preamble index for the on-demand SIB to acknowledge reception of the PRACH.

29. The method of claim 27, wherein the PDCCH for the RAR indicates scheduling information for the on-demand SIB, and wherein transmitting the on-demand SIB includes transmitting a physical downlink shared channel (PDSCH) that includes the on-demand SIB based at least in part on the scheduling information indicated in the PDCCH for the RAR.

30. The method of claim 27, wherein the PDCCH for the RAR indicates a transmission scheme for the on-demand SIB.
